(19) United States
(12) Patent Application Publication
(10) Pub. No.: US 2010/0278112 A1
(43) Pub. Date: Nov. 4, 2010

(54) BINDING UPDATE METHOD AND MOBILE TERMINAL DEVICE USED FOR SAME

(75) Inventor: Tetsuro Morimoto, Kanagawa (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/812,302

(22) PCT Filed: Dec. 26, 2008
(86) PCT No.: PCT/JP2008/004020

§ 371 Date: Jul. 9, 2010

(30) Foreign Application Priority Data
Jan. 18, 2008 (JP) 2008-009457

(51) Int. Cl. H04W 40/00

(52) U.S. Cl. 370/328

(57) ABSTRACT

Disclosed is a technique for providing a binding updating method and the like, capable of reducing the number of messages, and hence the power consumption of terminals and processing time required for binding update between both terminals. According to the technique, a first mobile terminal sends a second mobile terminal a first pair of messages including predetermined information on the first mobile terminal to acquire predetermined information on the second terminal. The second mobile terminal sends the first mobile terminal a second pair of messages including the predetermined information on the second mobile terminal. The first mobile terminal sends a third message to which authentication information is added, the authentication information generated based on the predetermined information on the second mobile terminal. The second mobile terminal sends a fourth message including response information to the third message and to which authentication information is added, the authentication information generated based on the predetermined information on the first mobile terminal. When the authentication information from the first mobile terminal is valid, the second mobile terminal updates binding information, while when the authentication information from the second mobile terminal is valid, the first mobile terminal updates the binding information.

### TECHNICAL FIELD

The present invention relates to a binding updating method for updating binding between communication terminals with a path optimized by binding update, and a mobile terminal used by the method.

### BACKGROUND ART

Conventionally, there has been a mobile IP as a technique in which even if a communication device has moved, it can continue to use the same IP address as before moving. In the mobile IP, a home agent receives a packet destined to the home address of a mobile node, and forwards it to a care-of address (CoA) of the mobile node. This enables the mobile node to continue communication using the home address regardless of the address change as a result of moving.

Further, in order to remedy the problem that a communication path between the mobile node and a correspondent node (CN) goes a long way because the packet is routed through the home agent, there is a route optimization technique for directly connecting the mobile node and the correspondent node through a communication path. This route optimization technique features that information of mapping the home address and the care-of address of the mobile node is stored at the correspondent node so that communication will be performed using the care-of address. Processing for storing the information of mapping the home address and the care-of address of the mobile node at this correspondent node is called binding update (BU) processing.

The binding update processing for the correspondent node differs from binding update processing for the home agent in that it requires binding update preprocessing (RR: Return Routability Procedure). Since a confidential relationship can be established between the home agent and the mobile node in advance, this binding update preprocessing is not required. In the binding update processing for the home agent, when the mobile node notifies the home agent of a new care-of address for the home address, the home agent can confirm that the notification is a binding update request from the mobile node based on the confidential relationship (IPsec SA or the like) established beforehand.

On the other hand, it is difficult for the correspondent node to establish confidential relationships between the mobile node and the correspondent node for all possible communication devices as communication partners before performing binding update processing. If the correspondent node complies with a binding update request without any confidential relationship, it makes it easy for an attacker to pretend to be a mobile node. In this case, if the attacker performs binding update processing for the correspondent node, it allows a packet for the mobile node to be forwarded to an unauthorized care-of address. A technique for preventing this is binding update preprocessing.

Specifically, in the binding update preprocessing, home address test processing (Home Test) and care-of address test processing (Care-of Test) are performed. These processing results are reflected in the binding update processing to prevent unauthorized binding update processing. The mobile IP, route optimization and binding update preprocessing as conventional techniques are described in Non-Patent Document 1 cited below. The design concept of the binding update preprocessing is described in Non-Patent Document 2 cited below.

The binding update preprocessing will be described in a little more detail. In the home address test processing, the mobile node sends the correspondent node a HoTI (Home Test Init) message, and the correspondent node returns a HoT (Home Test) message. In the care-of address test processing, the mobile node sends the correspondent node a CoTI (Care-of Test Init) message, and the correspondent node returns a CoT (Care-of Test) message.

The mobile node generates a key based on a Home keygen token (Home token) and a Care-of keygen token (Care-of token) included in the HoT message and the CoT message returned from the correspondent node, calculates a message authentication code (MAC) of a binding update (BU) message using the key, and sends a BU message with the MAC added thereto.

The correspondent node that has received the BU message checks the message authentication code and determines that it is a valid BU message from the mobile node. According to Non-Patent Document 2 in which the design concept of the binding update preprocessing is described, this binding update preprocessing is so designed that the correspondent node will not have to have State. In other words, the correspondent node can perform authentication processing on the BU message without storing information as to whether it has ever received a HoTI message and a CoTI message.

This is to minimize the damage to the correspondent node when an attacker uses a HoTI message or CoTI message to make a DoS (Denial of Service) attack against the correspondent node. Further, a HoT message is returned in response to a HoTI message, and a CoT message is returned in response to a CoTI message. Thus, one response message is returned in response to one request message. This is to prevent the amplification of messages. If two or more response messages are returned in response to one request message, the attacker can attack two or more targets by sending one message.

Non-Patent Document 1: “Mobility Support in IPv6,” RFC3775

Non-Patent Document 2: “Mobile IP Version 6 Route Optimization Security Design Background,” RFC4225

However, there is a problem that MIPv6 in the aforementioned conventional techniques cannot make effective use of a situation in which mobile terminals are performing binding update to each other. In other words, a conventional mobile node cannot change the binding update procedure for the purpose of processing efficiency even when a correspondent node is performing binding update to the mobile node.

Further, in order that the mobile node and the correspondent node continue communication with the optimized path, both have to perform binding update periodically (every seven minutes) to maintain the binding cache. In this case, maintaining the binding cache of one node (terminal) is not sufficient, but the conventional techniques do not allow each of the nodes to perform binding update independently.

Specifically, as shown in FIGS. 19A and B, terminal A (MN_A) and terminal B (MN_B) perform binding update processing independently every seven minutes to update the life time of a binding cache (information on home address and care-of address) notified to the correspondent terminal, and this increases the number of messages.

### DISCLOSURE OF THE INVENTION

In view of the above-mentioned problems, it is an object of the present invention to provide a binding updating method and a mobile terminal used by the method, capable of reducing the number of messages required for binding update between both terminals, reducing the power consumption of terminals due to the reduction in the number of messages, and further reducing the processing time required for binding update between both terminals.

In order to attain the above object, according to the present invention, there is provided a binding update method for updating binding information for enabling route optimization between a first mobile terminal and a second mobile terminal as a correspondent terminal of the first mobile terminal, and when the first mobile terminal has the binding information on the second mobile terminal, the method comprising the steps of: causing the first mobile terminal to send the second mobile terminal a first pair of messages as messages including predetermined information on the first mobile terminal to acquire predetermined information on the second mobile terminal from the second mobile terminal; causing the second mobile terminal to send the first mobile terminal a second pair of messages including the predetermined information on the second mobile terminal; causing the first mobile terminal to send the second mobile terminal a third message to which authentication information is added, the authentication information generated based on the predetermined information on the second mobile terminal included in the second pair of messages; causing the second mobile terminal to send the first mobile terminal a fourth message as a message including response information to the third message and to which authentication information is added, the authentication information generated based on the predetermined information on the first mobile terminal, and to update the binding information when the authentication information from the first mobile terminal is valid; and causing the first mobile terminal to update the binding information when the authentication information added to the fourth message from the second mobile terminal is valid. This configuration can reduce the number of messages required for binding update between both terminals, and due to the reduction in the number of messages, the power consumption of terminals can be reduced, and the processing time required for binding update between both terminals can also be reduced.

According to a preferred form of the present invention, the binding update method of the present invention is such that the second mobile terminal sends the first mobile terminal the predetermined information on the first mobile terminal by including the predetermined information in the second pair of messages, and the first mobile terminal sends the second mobile terminal the predetermined information on the first mobile terminal included in the second pair of messages by including the predetermined information on the first mobile terminal in the third message. This configuration can reduce damage when subjected to a DoS attack.

According to another form of the present invention, the binding updating method of the present invention is such that the second mobile terminal sends the predetermined information on the first mobile terminal by including the predetermined information on the first mobile terminal in the second pair of messages in such a format that the predetermined information on the first mobile terminal can be decoded by only the second mobile terminal. This configuration can prevent reading by another terminal.

According to still another form of the present invention, the binding updating method of the present invention is such that the predetermined information on the first mobile terminal is tokens (Token) generated based on a home address and a care-of address (CoA) of the second mobile terminal, the predetermined information on the second mobile terminal is tokens (Token) generated based on a home address and a care-of address (CoA) of the first mobile terminal, the first pair of messages are messages for requesting the second mobile terminal to start a home address test (Home Test Init) and a care-of address test (Care-Of Test Init), the second pair of messages are a HoT message and a CoT message to respond to the first pair of messages, the third message is a binding update message to the second mobile terminal, and the fourth message is a binding update message to the first mobile terminal. This configuration enables appropriate route optimization.

According to the present invention, there is also provided a mobile terminal used by a binding update method for updating binding information for enabling route optimization between the mobile terminal and a correspondent terminal as a communication partner of the mobile terminal, and when the mobile terminal has the binding information on the correspondent terminal, the mobile terminal comprising: message creation means for creating a first pair of messages as messages including predetermined information on the mobile terminal to acquire predetermined information on the correspondent terminal from the correspondent terminal; transmitting means for sending the generated first pair of messages to the correspondent terminal; receiving means for receiving, from the correspondent terminal, a second pair of messages including the predetermined information on the correspondent terminal; authentication information generating means for generating authentication information based on the received predetermined information on the correspondent terminal; and updating means for updating the binding information, wherein the message creation means creates a third message to which the authentication information generated by the authentication information generating means is added, the transmitting means sends the generated third message to the correspondent terminal, and the updating means determines whether authentication information is valid, which is the information received through the receiving means and generated by the correspondent terminal based on the predetermined information on the mobile terminal, and if valid, the updating means updates the binding information. This configuration can reduce the number of messages required for binding update between both terminals, and due to the reduction in the number of messages, the power consumption of terminals can be reduced, and the processing time required for binding update between both terminals can also be reduced.

Further, according to the present invention, there is provided a mobile terminal used by a binding update method for updating binding information for enabling route optimization between the mobile terminal and a correspondent terminal as a communication partner of the mobile terminal, the mobile terminal comprising: receiving means for receiving a first pair of messages as messages including predetermined information on the correspondent terminal to acquire predetermined information on the mobile terminal from the mobile terminal; message creation means for creating a second pair of messages including the predetermined information on the mobile terminal; transmitting means for sending the correspondent terminal the generated second pair of messages; authentication information generating means for generating authentication information based on the predetermined information on the correspondent terminal received through the receiving means; and updating means for updating the binding information when authentication information as information received through the receiving means and generated by the correspondent terminal based on the predetermined information on the mobile terminal is valid, wherein the message creation means creates a third message to which the authentication information generated by the authentication information generating means is added, and the transmitting means sends the generated third message to the correspondent terminal. This configuration can reduce the number of messages required for binding update between both terminals, and due to the reduction in the number of messages, the power consumption of terminals can be reduced, and the processing time required for binding update between both terminals can also be reduced.

According to a preferred form of the present invention, the mobile terminal of the present invention is such that the message creation means creates the third message including the predetermined information on the mobile terminal included in the second pair of messages. This configuration can reduce damage when subjected to a DoS attack.

According to another preferred form of the present invention, the mobile terminal of the present invention is such that the message creation means creates the second pair of messages including the predetermined information on the correspondent terminal included in the first pair of messages. This configuration can reduce damage when subjected to a DoS attack.

According to still another preferred form of the present invention, the mobile terminal of the present invention is such that the message creation means includes the predetermined information on the correspondent terminal in the third message in such a format that the predetermined information on the correspondent terminal can be decoded by only the mobile terminal. This configuration can prevent reading by another terminal.

According to yet another preferred form of the present invention, the mobile terminal of the present invention is such that the message creation means includes the predetermined information on the correspondent terminal in the second pair of messages in such a format that the predetermined information on the correspondent terminal can be decoded by only the mobile terminal. This configuration can prevent reading by another terminal.

According to yet another preferred form of the present invention, the mobile terminal of the present invention is such that the predetermined information on the mobile terminal is tokens (Token) generated based on a home address and a care-of address (CoA) of the correspondent terminal, the predetermined information on the correspondent terminal is tokens (Token) generated based on a home address and a care-of address (CoA) of the mobile terminal, the first pair of messages are messages for requesting the correspondent terminal to start a home address test (Home Test Init) and a care-of address test (Care-Of Test Init), the second pair of messages are a HoT message and a CoT message to respond to the first pair of messages, and the third message is a binding update message to the correspondent terminal. This configuration enables appropriate route optimization.

According to still another preferred form of the present invention, the mobile terminal of the present invention is such that the predetermined information on the correspondent terminal is tokens (Token) generated based on a home address and a care-of address (CoA) of the mobile terminal, the predetermined information on the mobile terminal is tokens (Token) generated based on a home address and a care-of address (CoA) of the correspondent terminal, the first pair of messages are messages for requesting the mobile terminal to start a home address test (Home Test Init) and a care-of address test (Care-Of Test Init), the second pair of messages are a HoT message and a CoT message to respond to the first pair of messages, and the third message is a binding update message to the correspondent terminal. This configuration enables appropriate route optimization.

According to the present invention, the binding updating method and the mobile terminal used by the method have the aforementioned configurations, so that the number of messages required for binding update between both terminals can be reduced, and due to the reduction in the number of messages, not only the power consumption of terminals but also the processing time required for binding update between both terminals can be reduced.

### BRIEF DESCRIPTION OF THE DRAWINGS

FIG. 1A It is an illustration for describing reduction in the number of messages in a first embodiment of the present invention.

FIG. 1B It is another illustration for describing reduction in the number of messages in the first embodiment of the present invention.

FIG. 2 It is a block diagram showing an example of the configuration of a mobile terminal according to the first embodiment of the present invention.

FIG. 3 It is a block diagram showing an example of the configuration of another mobile terminal according to the first embodiment of the present invention.

FIG. 4 It is an illustration for describing the basic principle of MIP to describe a second embodiment of the present invention.

FIG. 5 It is another illustration for describing the basic principle of MIP to describe the second embodiment of the present invention.

FIG. 6 It is an illustration for describing reduction in the number of messages in the second embodiment of the present invention.

FIG. 7 It is an illustration for describing the second embodiment of the present invention in further detail.

FIG. 8 It is a diagram showing a state of exchanging information between both terminals in the second embodiment of the present invention.

FIG. 9 It is a block diagram showing an example of the configuration of a mobile terminal according to the second embodiment of the present invention.

FIG. 10 It is a block diagram showing an example of the configuration of another mobile terminal according to the second embodiment of the present invention.

FIG. 11 It is a flowchart showing an example of a processing flow of a mobile terminal on the side of initiating a combined binding update in the second embodiment of the present invention.

FIG. 12A It is a flowchart showing an example of a processing flow of a mobile terminal on the side of responding to a combined binding update in the second embodiment of the present invention.

FIG. 12B It is a flowchart showing an example of a processing flow of mobile terminal on the side of responding to a combined binding update in the second embodiment of the present invention.

FIG. 13 It is an illustration for describing reduction in the number of messages in a third embodiment of the present invention.

FIG. 14 It is a diagram showing a state of exchanging information between both terminals in the third embodiment of the present invention.

FIG. 15 It is a block diagram showing an example of the configuration of a mobile terminal according to the third embodiment of the present invention.

FIG. 16 It is a block diagram showing an example of the configuration of another mobile terminal according to the third embodiment of the present invention.

FIG. 17 It is a flowchart showing an example of a processing flow of a mobile terminal on the side of initiating a combined binding update in the third embodiment of the present invention.

FIG. 18A It is a flowchart showing an example of a processing flow of a mobile terminal on the side of responding to a combined binding update in the third embodiment of the present invention.

FIG. 18B It is a flowchart showing an example of a processing flow of mobile terminal on the side of responding to a combined binding update in the third embodiment of the present invention.

FIG. 19A It is an illustration for describing a conventional binding update between both terminals.

FIG. 19B It is an illustration for describing the conventional binding update between both terminals.

### BEST MODE FOR CARRYING OUT THE INVENTION

### First Embodiment

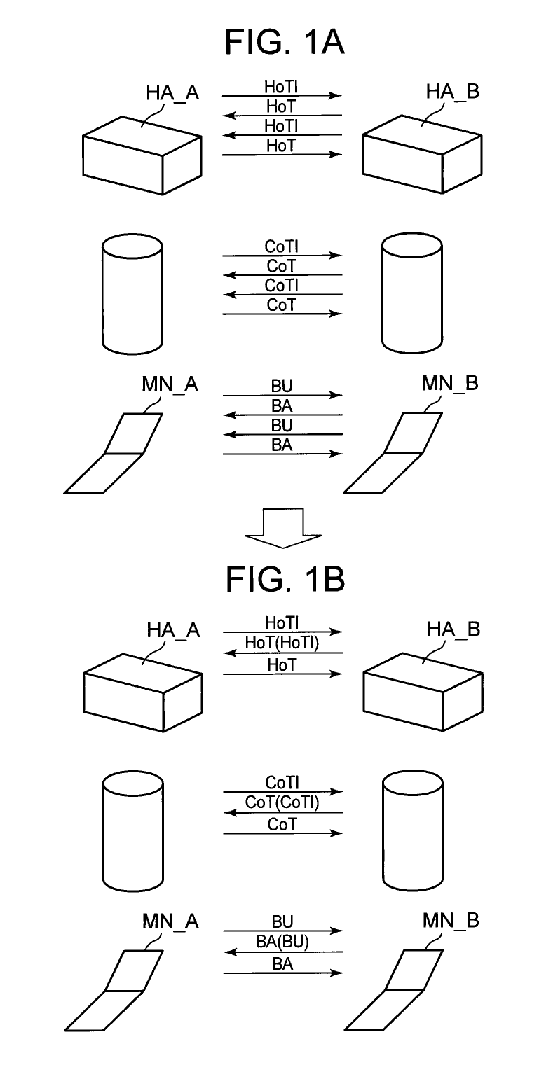

A first embodiment will now be described. In order to reduce the number of many messages as shown in FIG. 1A, both terminals are made to perform binding update synchronously as shown in FIG. 1B in such a manner that a receiving terminal will overlap and send messages.

In other words, as shown in FIG. 1B, terminal B performs a binding update in synchronization with a binding update procedure started by terminal A (hereinafter referred to as combined binding update). The terminal B returns a HoT as a response to a HoTI from the terminal A and sends a HoTI at the same time. Similarly, the terminal B returns a CoT as a response to a CoTI from the terminal A and sends a CoTI at the same time. Then, the terminal B returns a BA as a response to a BU from the terminal A and sends a BU at the same time. At this time, the terminal B can combine, into one message, the HoT and the HoTI, the CoT and the CoTI, and the BA and the BU to be sent from the terminal B, enabling reduction in the number of messages.

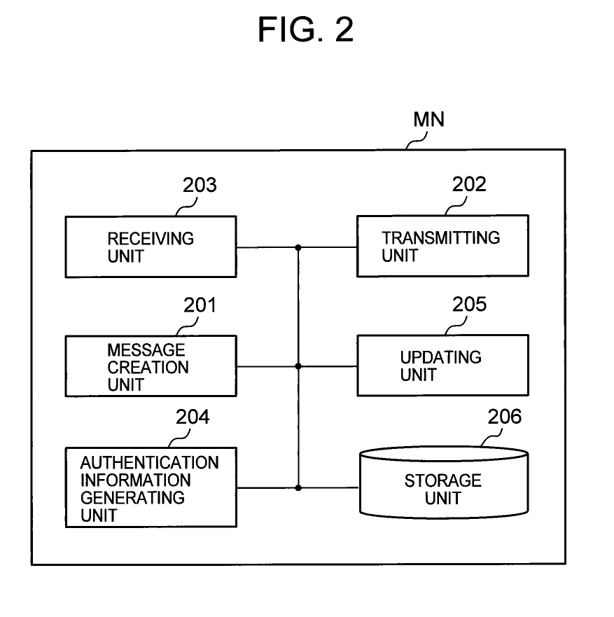

Here, a mobile terminal (here, terminal A) on the side of initiating a combined binding update will be described with reference to FIG. 2. A message creation unit 201 creates HoTI and CoTI messages to acquire information B1 and B2 from a correspondent terminal (terminal B), respectively. A transmitting unit 202 sends the created HoTI and CoTI messages to the terminal B. A receiving unit 203 receives a HoT message as a message including the information B1 to acquire information A1 and a CoT message as a message including the information B2 to acquire information A2.

An authentication information generating unit 204 generates authentication code(s) based on the information B1 and B2, respectively. The generated authentication code(s) are sent from the transmitting unit 202 to the terminal B. An updating unit 205 determines whether authentication code(s) are valid, which are generated by the terminal B based on the information A1 and A2 as code information received through the receiving unit 203, and if valid, the updating unit 205 updates binding information. A storage unit 206 stores information such as binding caches.

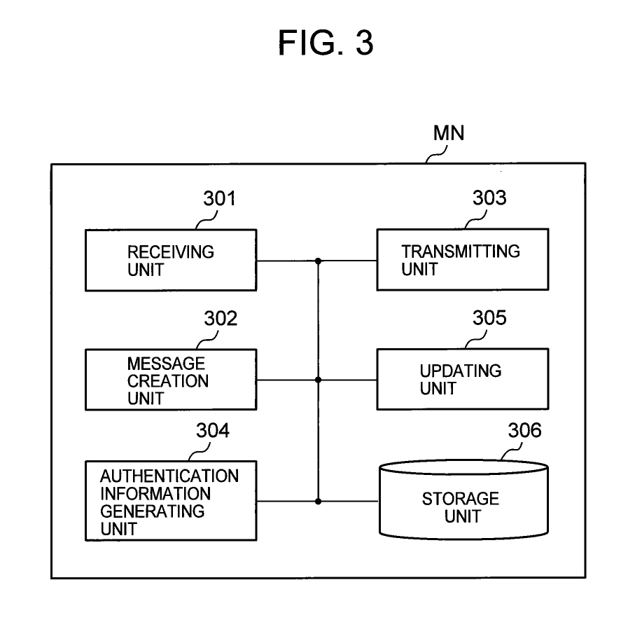

Next, a mobile terminal (here, terminal B) on the side of responding to a combined binding update will be described with reference to FIG. 3. A receiving unit 301 receives the HoTI and CoTI messages from the terminal A to acquire the information B1 and B2. A message creation unit 302 creates the HoT message as a message including the information B1 to acquire the information A1 from the terminal A, and the CoT message as a message including the information B2 to acquire the information A2 from the terminal A.

A transmitting unit 303 sends the generated HoT and CoT messages to the terminal A. An authentication information generating unit 304 generates authentication code(s) based on the information B1 and B2 received through the receiving unit 301. The generated authentication code(s) are sent from the transmitting unit 303 to the terminal A. An updating unit 305 determines whether the authentication code(s) are valid respectively, which are generated by the terminal A based on the information B1 and B2 as the information received through the receiving unit 301, and if valid, the updating unit 305 updates binding information. A storage unit 306 stores information such as binding caches.

### Second Embodiment

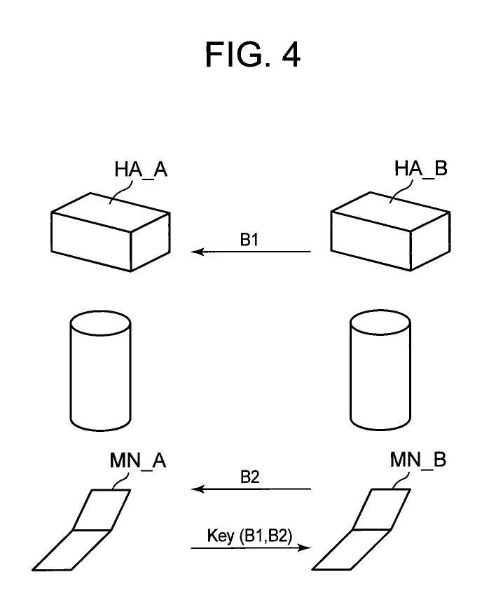

A second embodiment will be described. First of all, the basic principle of MIP will be described. FIG. 4 shows the state of a binding update from the terminal A. The terminal A is about to prove to the terminal B that a care-of address (CoA) is its own address. To this end, the terminal A gets the terminal B to send messages to the home address (HoA) and CoA of the terminal A, respectively, showing the terminal B received both messages.

Briefly, the terminal B sends information B1 to the HoA of the terminal A, and information B2 to the CoA of the terminal A. Using B1 and B2, the terminal A generates Keys (B1, B2) as key data, and using the key data, it generates authentication code(s). The terminal B checks the authentication code(s) from the terminal A to confirm that the terminal A has generated correct key data successfully, determining that the terminal A has received the information B1 and information B2.

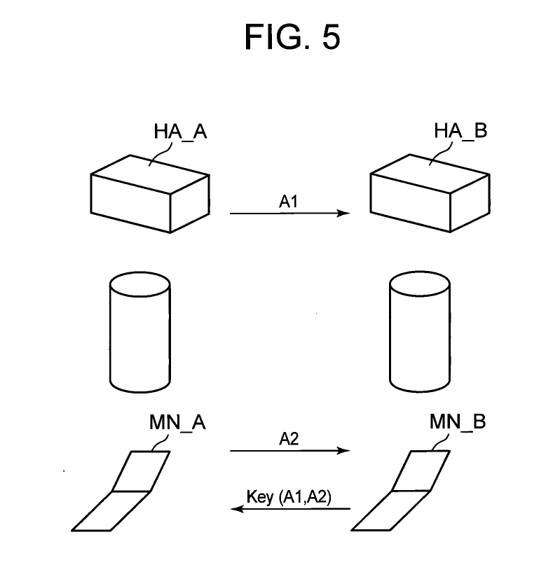

More specifically, the terminal A sends a HoTI to the terminal B to require the terminal B to include the information B1 in a HoT and send the HoT to the HoA of the terminal A. The terminal A also sends a CoTI to the terminal B to require the terminal B to include the information B2 in a CoT and send the CoT to the CoA of the terminal A. Then, using the information B1 and information B2, Keys (A1, A2) as key data are generated, and using the keys, authentication code(s) for a BU message to be sent are generated, the authentication code(s) are added to the BU message, and the BU message is sent to the terminal B. When receiving the BU, the terminal B generates key data from B1 and B2, and checks whether the authentication code(s) are correct. FIG. 5 shows the state of a binding update from the terminal B.

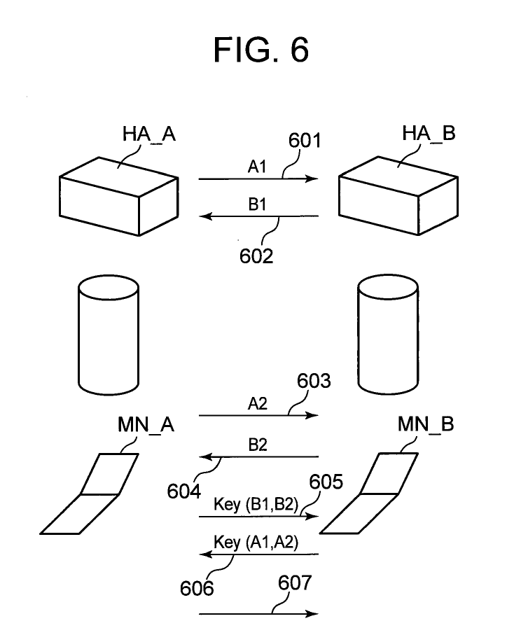

Based on the above description, an embodiment capable of reducing more messages than the aforementioned first embodiment will be described with reference to FIG. 6. In this embodiment, the terminal A sends information A1 to HoA of the terminal B and information A2 to CoA of the terminal B before receiving a request from the terminal B. Conventionally, these are information to be returned after HoTI and CoTI messages are received from the terminal B. However, if the terminal A has a binding cache of the terminal B, since the terminal A already knows the HoA and CoA of the terminal B, binding update processing of the terminal B can be initiated from the terminal A as shown in FIG. 6.

Further, using a HoTI message 601 and a CoTI message 603 to the terminal B, the terminal A can send the information A1 and information A2. In this case, the terminal A can also initiate a binding update of the terminal A at the same time. The terminal A receives a HoT message 602 and a CoT message 604 as response messages from the terminal B, generates key data (Key(B1, B2)) using information B1 and B2 included in the response messages, and sends a BU message 605 to show that the key data (Key(B1, B2)) has been generated successfully.

The terminal B checks the BU message 605 to acknowledge the binding update of the terminal A while generating key data (Key(A1, A2)) based on the information A1 and information A2 previously sent to show that the terminal B has successfully generated the key data (Key(A1, A2)) upon transmission of a BA message 606 as a response to the BU message 605. The terminal A checks the BA message 606 and acknowledges the binding update of the terminal B. The terminal A may send the terminal B a message 607 indicative of completion of acknowledgement. Thus, use of the method of the embodiment can result in the reduction of more messages required for the binding updates than that of the first embodiment.

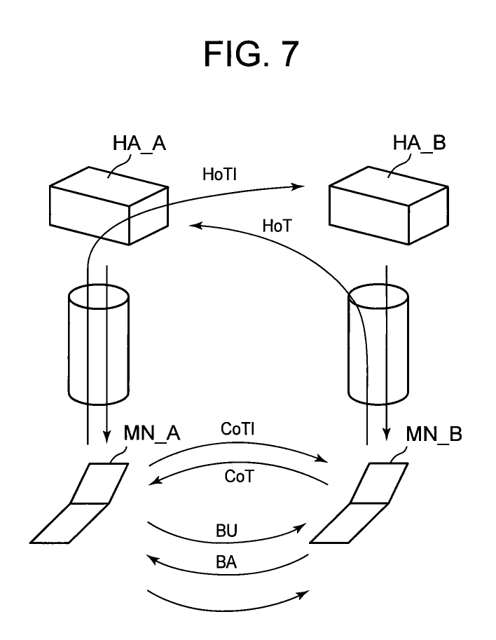

Here, the second embodiment will be described in more detail. Suppose that the terminal A receives a binding update from the terminal B and that the terminal A is aware of a home address B-HoA and a care-of address B-CoA of the terminal B. In this case, when performing a binding update to the terminal B, the terminal A checks whether it has binding cache information on the terminal B. If it does not have, normal MIP binding update processing is performed. On the other hand, if the terminal A has the binding cache information on the terminal B, both of the binding updates of the terminal A and the terminal B are tried at the same time as shown in FIG. 7.

The terminal A sends a HoTI to the HoA of the terminal B. Since the source address is the HoA of the terminal A, a response message HoT from the terminal B is sent to the HoA of the terminal A, which is the source address. Information A1 is included in the message HoTI. When receiving the HoTI, the terminal B sends a response message HoT to the terminal A. Since this is a response to the message received at the HoA of the terminal B, the source address is the HoA of the terminal B, and the destination address is the HoA of the terminal A, which is the source address of the request message HoTI.

Similarly, the terminal A returns a CoTI to the CoA of the terminal B. The source address is the CoA of the terminal A. Information A2 is included in the CoTI message. When receiving the CoTI, the terminal B sends a response message CoT to the terminal A. Since this is a response to the message received at the CoA of the terminal B, the source address is the CoA of the terminal B, and the destination address is the CoA of the terminal A, which is the source address of the request message CoTI.

Using the information B1 and B2 included in the HoT and CoT as the response messages, the terminal A generates key data, and using the key data, generates authentication code(s), adds the authentication code(s) to a BU message, and sends the BU message to the terminal B. When receiving the BU message, the terminal B checks the authentication code(s) and if it determines whether the binding cache of the terminal A is correct, thereby extending the life time. Further, upon sending a BA as a response message, the terminal B generates key data using the information A1 and A2 included in the HoTI and CoTI, generates authentication code(s) using the key data, adds the authentication code(s) to the BA message, and sends the BA message to the terminal A. When receiving the BA message, the terminal A checks the authentication code(s) and if it determines whether the binding cache of the terminal B is correct, thereby extending the life time.

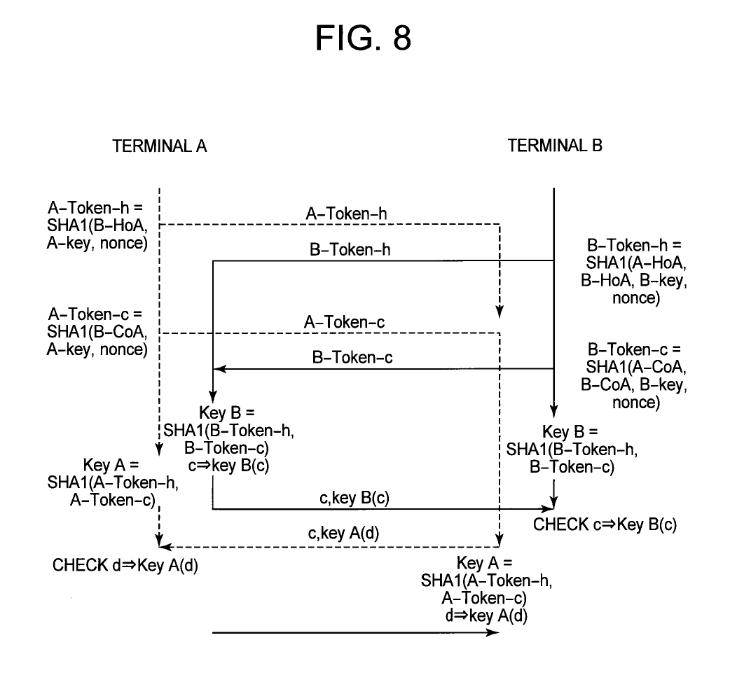

The above state will be described in further detail with reference to FIG. 8. The terminal A sends the terminal B a HoTI with A-Token-h added thereto. The method of generating A-Token-h may be any method in principle and does not need to be particularly specified. However, as a method for making the most of MIP as the conventional technique, the following generation method can be considered:

A-Token-h=HMAC SHA1 (B-HoA, A-Key, nonce)

Here, a hash function (HMAC SHA1) is used to calculate the token value, but any other function or any other generation expression may be used.

B-HoA denotes the home address of the terminal B, and A-Key denotes a secret key of the terminal A. Nonce is a random number used by the terminal A to generate Home Token. The terminal B receives a HoTI from the terminal A and returns a HoT as a response. B-Token-h and B-nonce-h are included in the HoT. The method of calculating B-Token-h is different from that of the conventional MIP. In the conventional MIP, B-Token-h is calculated as follows:

B-Token-h=HMAC SHA1 (A-HoA, B-Key, B-nonce-h)

In the method of the present invention, it is calculated as follows:

B-Token-h=HMAC SHA1 (A-HoA, B-HoA, B-Key, B-nonce-h)

In other words, B-Token-h is calculated by adding the home address B-HoA of the terminal B. A-HoA used to calculate B-Token-h is the source address of the HoTI message, and B-HoA is the destination address. Further, A-Token-h included in the HoTI message is stored by the terminal B. For example, it is considered a method in which an area for storing Home Token is reserved in the binding cache of the terminal A to store therein the latest value sent.

The terminal A may also send a CoTI in parallel with transmission of the HoTI. In other words, it may send the CoTI before receiving the HoT. Further, the CoTI may be sent before the HoTI. The terminal A sends the terminal B the CoTI with A-Token-c added thereto. The following method can be considered as the method of generating A-Token-c:

A-Token-c=HMAC SHA1 (B-CoA, A-Key, nonce)

B-CoA is the care-of address of the terminal B, and A-Key is a secret key of the terminal A. Nonce is a random number used by the terminal A to generate Care-of Token. The terminal B receives the CoTI from the terminal A and returns a CoT as a response. B-Token-c and B-nonce-c are included in the CoT. Unlike the conventional MIP, B-Token-c is calculated as follows:

B-Token-c=HMAC SHA1 (A-CoA, B-CoA, B-Key, B-nonce-c)

In other words, B-Token-c is calculated by adding the care-of address B-CoA of the terminal B. A-CoA used to calculate B-Token-c is the source address of the CoTI message, and B-CoA is the destination address. Further, like A-Token-h, A-Token-c is stored by the terminal B. When receiving a HoT as a response to the HoTI message and a CoT as a response to the CoTI message, the terminal A generates Key B as key data using B-Token-h and B-Token-c included in the respective messages.

Key B=HMAC SHA1 (B-Token-h, B-Token-c)

Using the key data Key B, the terminal A generates an authentication code B-MAC for a BU message.

B-MAC=HMAC SHA1 (Key B, BU message)

The terminal A sends the terminal B the BU message by adding B-nonce-h, B-nonce-c, B-MAC, A-HoA and B-HoA. The terminal B receives the BU message and generates B-Token-h using B-nonce-h, B-HoA and A-HoA. The terminal B also generates B-Token-c using the source address A-CoA of the BU message, the destination address B-CoA and B-nonce-c. Then, the terminal B generates Key B using the generated B-Token-h and B-Token-c, and checks whether B-MAC added to the BU message is correct.

If the result of checking B-MAC is correct, the terminal B updates the life time of the binding cache of the terminal A. A new setting is also possible. On the other hand, if the result of checking B-MAC is not correct, the terminal B takes a measure such as to discard the message or return an error message. Further, the terminal B generates key data Key A using the information A-Token-h and A-Token-c stored therein as follows:

Key A=H MAC SHA1 (A-Token-h, A-Token-c)

Using the key data Key A, the terminal B generates an authentication code A-MAC for a BA message.

A-MAC=HMAC SHA1 (Key A, BA message)

The terminal B adds, to the BA message, not only the authentication code B-MAC generated from Key B in the same manner as normal MIP, but also the authentication code A-MAC generated using new Key A. The terminal A receives the BA message, verifies the authentication codes using Key B and Key A, and if the verification result is correct, updates the life time of the binding cache of the terminal B. If the verification result of the authentication code(s) is not correct, the terminal A takes a measure such as to discard the message or return an error message. Note that the above has described a case where Key A and Key B are separated from each other, but they may be combined into one piece of key data. For example, the following key data may be generated:

Key AB=H MAC SHA1 (A-Token-h, A-Token-c, B-Token-h, B-Token-c)

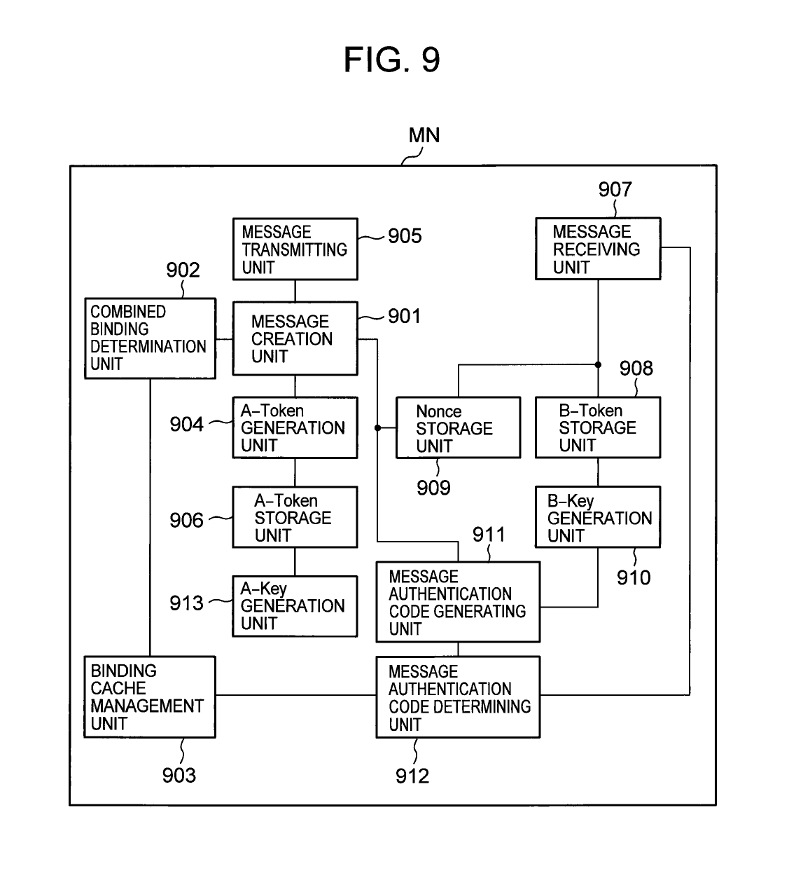

Next, a mobile terminal on the side of initiating a combined binding update will be described with reference to FIG. 9. First, transmission of a HoTI/CoTI will be described. A message creation unit 901 requests a combined binding determination unit 902 to determine whether the binding update is a normal binding update or a combined binding update. The combined binding determination unit 902 checks whether a binding cache from a correspondent terminal, which is going to perform a binding update, is registered in a binding cache management unit 903. If not registered, the normal binding update is performed.

If the combined binding update is performed, the message creation unit 901 has an A-Token generation unit 904 generate Home Token and Care-of Token, generates a HoTI message and CoTI message using the Tokens, and sends the messages from a message transmitting unit 905. The Home Token and Care-of Token generated in the A-Token generation unit 904 are stored in an A-Token storage unit 906.

Next, reception of HoT and CoT will be described. HoT and CoT messages as response messages to the HoTI and CoTI messages are received at a message receiving unit 907. The Tokens and Nonce-IDs (identification numbers used by the mobile terminal on the responding side to call the Nonce values) generated by the correspondent terminal and included in the received HoT and CoT are stored in a B-Token storage unit 908 and a Nonce storage unit 909.

Next, transmission of a BU will be described. When receiving both the HoT message and the CoT message, since both the Home Token and the Care-of Token are gathered in the B-Token storage unit 908, a B-Key generation unit 910 generates key data using these Tokens. Using the key data generated in the B-Key generation unit 910, a message authentication code generating unit 911 generates message authentication code(s) (corresponding to the above-mentioned authentication code(s)), and passes them to the message creation unit 901. The message creation unit 901 adds the generated message authentication code(s) to a BU message. The Nonce-IDs stored in the Nonce storage unit 909 are also added to the BU message. Then, the BU message is sent from the message transmitting unit 905.

Next, reception of a BA will be described. When the BA message is received at the message receiving unit 907, a message authentication code determining unit 912 makes a determination on the message. In order to determine the message, an A-Key generation unit 913 extracts the Home Token and the Care-of Token stored in the A-Token storage unit 906 to generate key data. The message authentication code generating unit 911 generates message authentication code(s) using the key data generated by the A-Key generation unit 913. The message authentication code determining unit 912 compares the generated message authentication code(s) with the message authentication code(s) added to the BU message to determine whether both are identical.

If the message authentication code(s) is identical, the binding cache is registered in the binding cache management unit 903. After that, the message creation unit 901 creates a response to the BA message, and the message transmitting unit 905 sends the response.

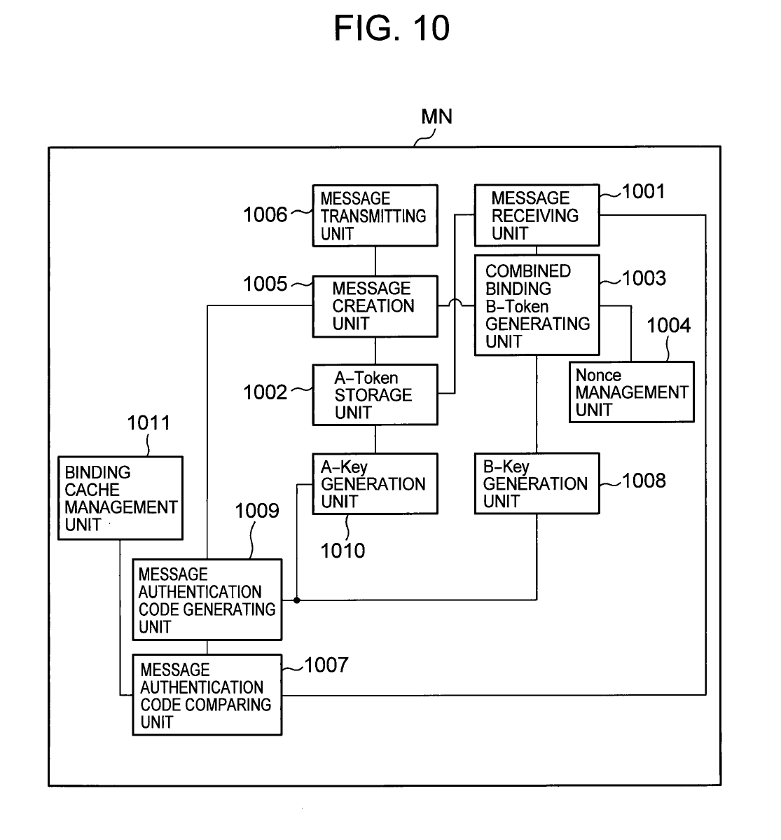

Next, a mobile terminal on the side of responding to a combined binding update will be described with reference to FIG. 10. First, reception of a HoTI/CoTI will be described. HoTI and CoTI messages are received at a message receiving unit 1001. In the case of a combined binding update, Home Token or Care-of Token included in the messages is passed to an A-Token storage unit 1002. Further, a combined binding B-Token generating unit 1003 generates B-Token (Home Token or Care-of Token). Nonce (home nonce or care-of nonce) necessary for generating B-Token is acquired from a Nonce management unit 1004.

B-Home Token=SHA1 (A-HoA, B-HoA, B-Key, B-home nonce)

B-Care-of Token=SHA1 (A-CoA, B-CoA, B-Key, B-care-of nonce)

Next, transmission of a HoT/CoT will be described. The Token generated by the combined binding B-Token generating unit 1003 and Nonce-ID for calling the Nonce used to generate the Token are acquired and added to a response message. When a received message is a HoTI, the response message is a HoT message, while when it is a CoTI, the response message is a CoT message. The response message created by a message creation unit 1005 is sent from a message transmitting unit 1006.

Next, reception of a BU will be described. A BU message is received at the message receiving unit 1001. In the case of a combined binding update, Home Token and Care-of Token are generated in the combined binding B-Token generating unit 1003. Nonce values are extracted from the Nonce management unit 1004 using Nonce-IDs included in the received BU message and used upon Token generation. Further, message authentication code(s) included in the BU message are passed to a message authentication code comparing unit 1007.

The Home Token and Care-of Token generated in the combined binding B-Token generating unit 1003 are passed to a B-Key generation unit 1008, and key data is generated in the B-Key generation unit 1008. Then, using the generated key data, message authentication code(s) are generated in a message authentication code generating unit 1009. In a message authentication code comparing unit 1007, the generated message authentication code(s) and the message authentication code(s) included in the BU message are compared to determine whether they are identical. If the message authentication code(s) are identical, a binding cache is set or updated in a binding cache management unit 1011.

Next, transmission of a BA will be described. Using the Tokens stored in the A-Token storage unit 1002, key data is generated in an A-Key generation unit 1010, and message authentication code(s) are generated in the message authentication code generating unit 1009. The message creation unit 1005 adds the generated message authentication code(s) to a BA message. The BA message is sent from the message transmitting unit 1006. A response message to the BA message is received at the message receiving unit 1001, the message authentication code(s) are checked, and the binding cache is updated in the binding cache management unit 1011.

As discussed above, the configuration of the mobile terminal on the side of initiating a combined binding update is different from that of the mobile terminal on the responding side. However, since all mobile terminals can become both the initiating and responding sides under normal conditions, it is preferred that any mobile terminal should have both functions on the initiating side and the responding side.

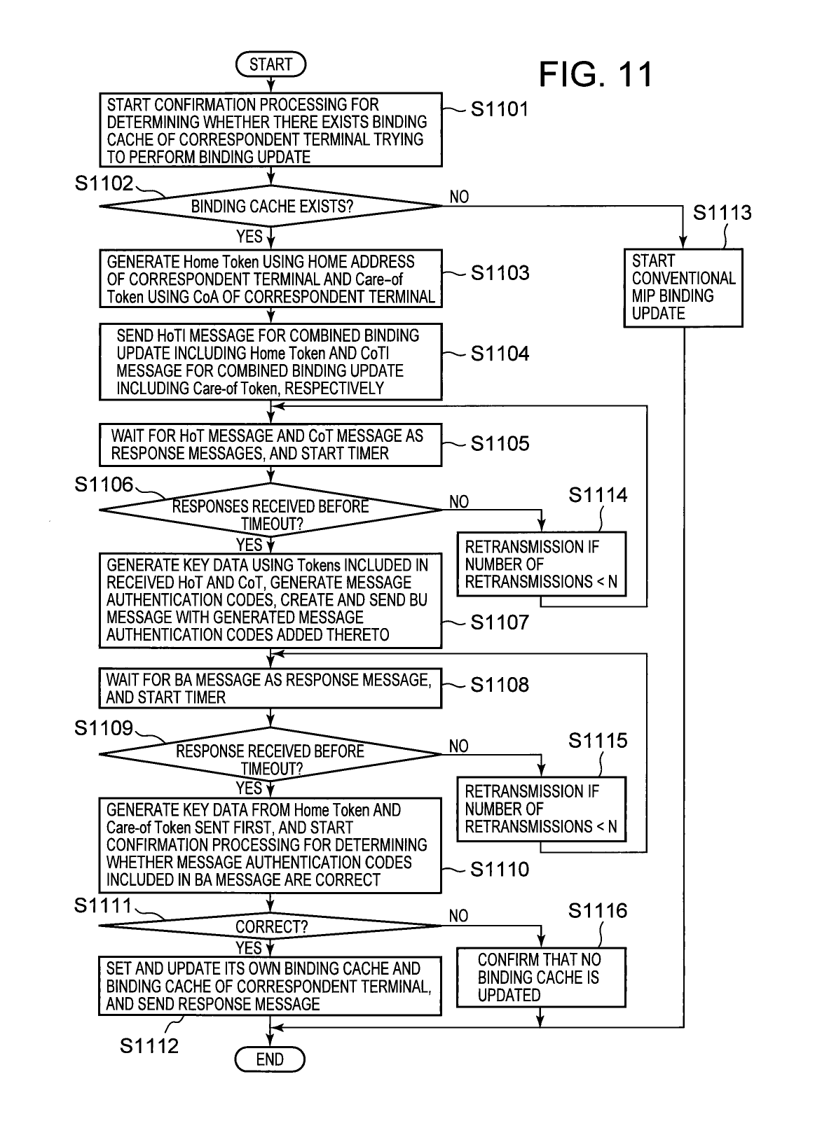

Next, a processing flow of a mobile terminal on the side of initiating a combined binding update will be described with reference to FIG. 11. As shown in FIG. 11, the mobile terminal starts confirmation processing for determining whether there is a binding cache of correspondent terminal trying to perform a binding update (step S1101) and determines whether a binding cache of the correspondent terminal exists (step S1102). If a binding cache exists, the mobile terminal generates Home Token using the home address of the correspondent terminal and Care-of Token using a CoA of the correspondent terminal (step S1103).

Then, the mobile terminal sends a HoTI message for a combined binding update including the Home Token and a CoTI message for a combined binding update including the Care-of Token, respectively (step S1104). The mobile terminal starts a timer while waiting for a HoT message and a CoT message as response messages (step S1105). The mobile terminal determines whether responses (messages) have been received before a timeout (step S1106).

If the response messages have been received before the timeout, the mobile terminal creates a BU message. In other words, the mobile terminal generates key data using Tokens included in the received HoT and CoT, generates message authentication code(s), creates the BU message with the generated message authentication code(s) added thereto, and sends the BU message (step S1107). The mobile terminal starts the timer while waiting for a BA message as a response message (step S1108). The mobile terminal determines whether the response (message) has been received before the timeout (step S1109).

If the response message has been received before the timeout, at the first step, the mobile terminal generates key data from the Home Token and Care-of Token transmitted and starts confirmation processing for determining whether message authentication code(s) included in the BA message are correct (step S1110). The mobile terminal determines whether the message authentication code(s) are correct (step S1111), and if determining whether they are correct, the mobile terminal sets and updates its own binding cache and a binding cache of the correspondent terminal, and sends a response message (step S1112).

In step S1102, if it is determined whether no binding cache exists, the mobile terminal starts a conventional MIP binding update (step S1113). Further, in step S1106 or S1109, if no response message has been received before the timeout, retransmission is performed on condition that the number of retransmissions is smaller than a predetermined numerical value N (step S1114, S1115). Further, in step S1111, if it determines whether the message authentication code(s) are incorrect, it is confirmed that no binding cache is updated (step S1116).

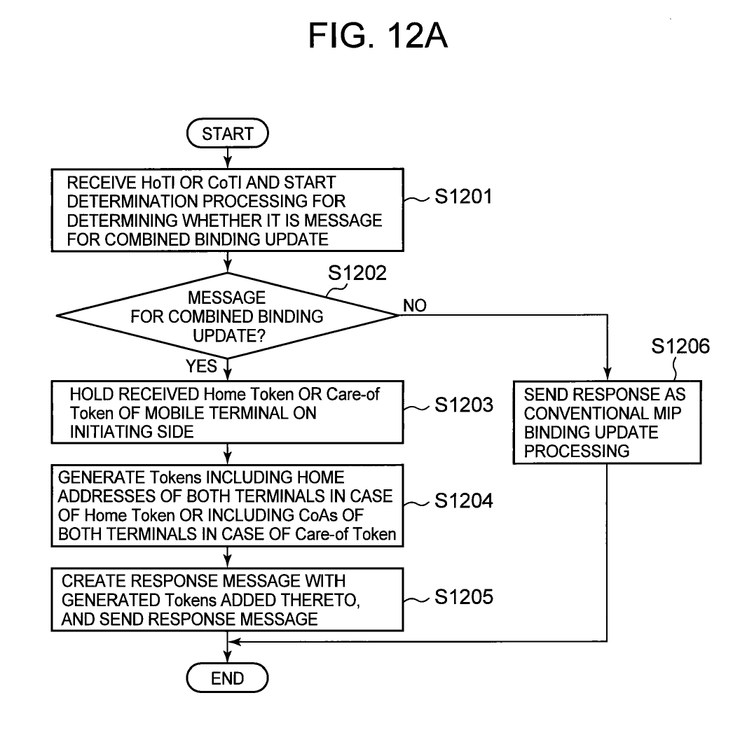

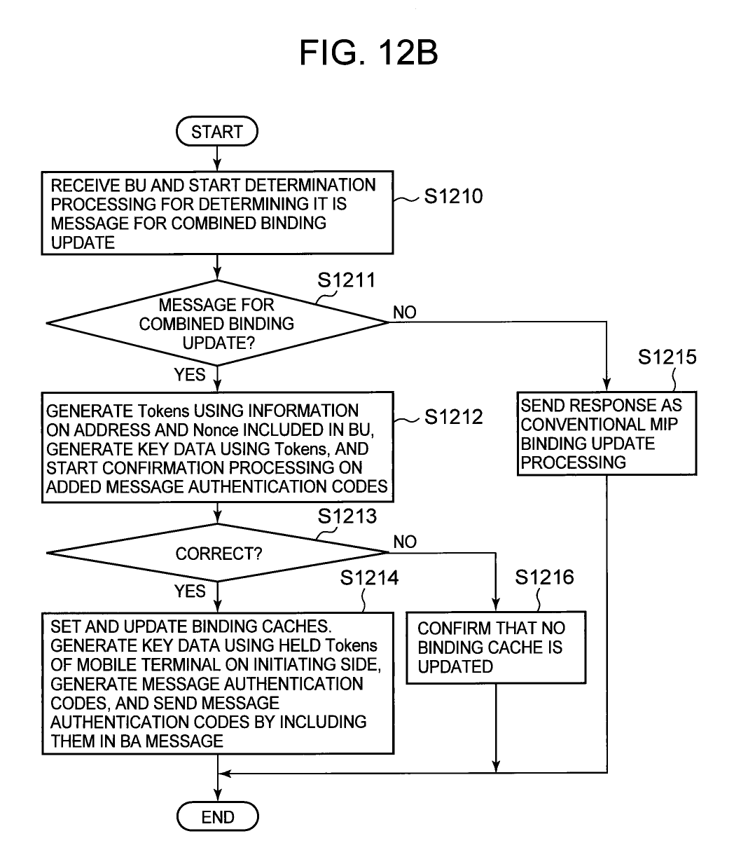

Next, a processing flow of a mobile terminal on the side of responding to a combined binding update (from reception of a message for the combined binding update to transmission of a response message) will be described with reference to FIG. 12A. As shown in FIG. 12A, the mobile terminal receives a HoTI or a CoTI, and starts determination processing for determining whether it is a message for the combined binding update (step S1201). The mobile terminal determines whether it is a message for the combined binding update (step S1202), and if it is the message for the combined binding update, the mobile terminal stores the received Home Token or Core-of Token of the initiating-side mobile terminal (step S1203).

The mobile terminal generates Tokens including the home addresses of both terminals in the case of the Home Token or including the CoAs of both terminals in the case of the Care-of Token (step S1204). The mobile terminal creates a response message with the generated Tokens added thereto, and sends the response message (step S1205). In step S1202, if determining whether it is not a message for the combined binding update, the mobile terminal sends a response as conventional MIP binding update processing (step S1206).

Next, a processing flow of a mobile terminal on the side of responding to a combined binding update (from reception of a BU message to transmission of a BA message) will be described with reference to FIG. 12B. As shown in FIG. 12B, the mobile terminal receives a BU (message), and starts determination processing for determining whether it is a message for the combined binding update (step S1210). The mobile terminal determines whether it is a message for the combined binding update (step S1211), and if it is the message for the combined binding update, the mobile terminal generates Tokens with the information on address and Nonce included in the BU, and generates key data with the Tokens, and starts confirmation processing on the added message authentication code(s) (step S1212).

The mobile terminal determines whether the message authentication code(s) are correct (step S1213), and if correct, the mobile terminal sets and updates binding caches, generates key data using the stored Tokens of the mobile terminal on the initiating side, generates message authentication code(s), and sends the message authentication code(s) by including them in a BA message (step S1214). In step S1211, if it is not a message for the combined binding update, the mobile terminal starts a conventional MIP binding update (step S1215). Further, in step S1213, if determining whether the message authentication code(s) are incorrect, the mobile terminal confirms that no binding cache is set and updated (step S1216).

### Third Embodiment

Like in the second embodiment, it is assumed that terminal A receives a binding update from terminal B and is aware of home address B-HoA and care-of address B-CoA of the terminal B. When performing a binding update to the terminal B, the terminal A checks whether it has the binding cache information on the terminal B. If it does not have, normal MIP binding update processing is performed. On the other hand, if the terminal A has the binding cache information on the terminal B, both the binding updates of the terminal A and the terminal B are tried at the same time. A third embodiment will be described also with reference to FIG. 7 used in describing the second embodiment.

The terminal A sends a HoTI to the HoA of the terminal B. Since the source address is the HoA of the terminal A, a response message HoT from the terminal B is sent to the HoA of the terminal A, which is the source address. Information A1 is included in the message HoTI. When receiving the HoTI, the terminal B sends a response message HoT to the terminal A. Since this is a response to the message received through the HoA of the terminal B, the source address is the HoA of the terminal B, and the destination address is the HoA of the terminal A, which is the source address of the request message HoTI.

Similarly, the terminal A returns a CoTI to the CoA of the terminal B. The source address is the CoA of the terminal A. Information A2 is included in the CoTI message. When receiving the CoTI, the terminal B sends a response message CoT to the terminal A. Since this is a response to the message received at the CoA of the terminal B, the source address is the CoA of the terminal B, and the destination address is the CoA of the terminal A, which is the source address of the request message CoTI.

Using the information B1 and B2 included in the HoT and CoT as the response messages, the terminal A generates key data, and using the key data, generates authentication code(s), adds the authentication code(s) to a BU message, and sends the BU message to the terminal B. When receiving the BU message, the terminal B checks the authentication code(s) and if it determines whether the binding cache of the terminal A is correct, thereby extending the life time.

Then, upon sending a BA as a response message, the terminal B generates key data using the information A1 and A2 included in the HoTI and CoTI, generates authentication code(s) using the key data, adds the authentication code(s) to the BA message, and sends the BA message to the terminal A. When receiving the BA message, the terminal A checks the authentication code(s) and if it determines whether the binding cache of the terminal B is correct, thereby extending the life time. So far the third embodiment is the same as the second embodiment.

The following describes the features of a binding information updating technique according to the third embodiment. When the terminal A starts binding updates for two terminals, the information A1 and A2 is sent from the terminal A to the terminal B and stored in the terminal B. From the standpoint of security, an attack (DoS attack) may be considered, where an attacker sends the terminal B massive amounts of HoTI and CoTI messages including different kinds of information to cause the terminal B to store the information and hence waste memory. To prevent this, when receiving a HoTI message 1301 and acquiring information A1, the terminal B can send it back to the terminal A by including the information in a HoT message 1302.

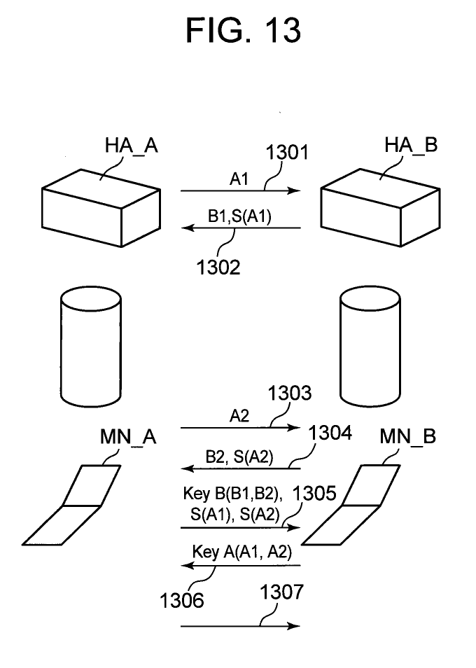

Such a state is shown in FIG. 13. Similarly, the terminal B receives a CoTI message 1303 and sends the information A2 back to the terminal A by including it in a CoT message 1304. The terminal A includes, in a BU message 1305, the information A1 and A2 sent back, and sends the BU message 1305 to the terminal B. The terminal B generates Key A(A1, A2) as key data using the information A1 and A2 included in the BU message 1305, and generates authentication code(s). Then, the terminal B includes, in a BA message 1306, the generated Key A(A1, A2), and sends the BA message 1306 to the terminal A. The terminal A checks the Key A(A1, A2), and when acknowledging a binding update of the terminal B, the terminal A may send the terminal B a message 1307 indicative of completion of acknowledgement. Further, upon sending the information A1 and A2 back to the terminal A, the terminal B may append its signature and encrypt the information before sending it back. Only the terminal B can verify the signature and decode it into the original information, and this can prevent the risk of being tampered or the like before the information is returned.

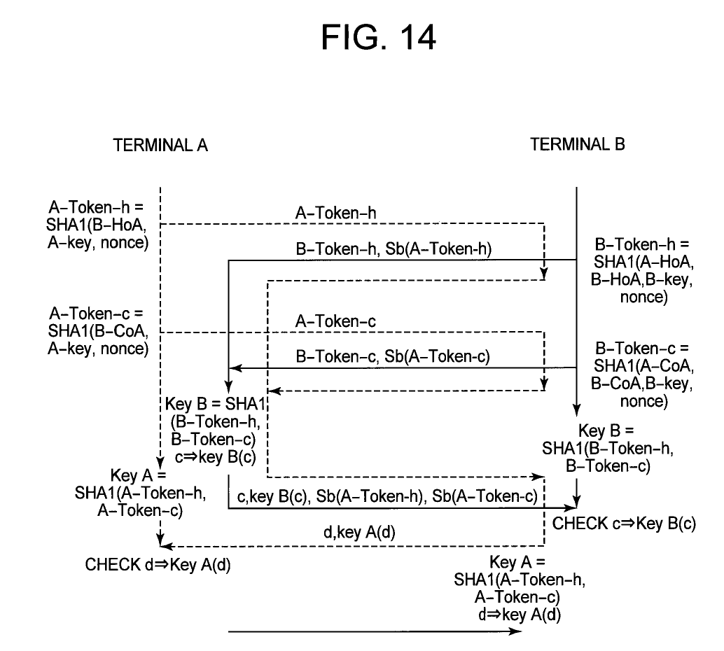

Here, a message sequence in the third embodiment will be described in detail with reference to FIG. 14. The terminal A sends the terminal B a HoTI with A-Token-h added thereto. The method of generating A-Token-h may be any method in principle and does not need to be particularly specified. However, as a method for making the most of MIP as the conventional technique, the following generation method can be considered:

A-Token-h=HMAC SHA1 (B-HoA, A-Key, nonce)

B-HoA denotes the home address of the terminal B, and A-Key denotes a secret key of the terminal A. Nonce is a random number used by the terminal A to generate Home Token. The terminal B receives a HoTI from the terminal A and returns a HoT as a response. B-Token-h, B-nonce-h and Sb(A-Token-h) are included in the HoT. The method of calculating B-Token-h is different from that of the conventional MIP. In the conventional MIP, B-Token-h is calculated as follows:

B-Token-h=HMAC SHA1 (A-HoA, B-Key, B-nonce-h)

In the method of the present invention, it is calculated as follows:

B-Token-h=HMAC SHA1 (A-HoA, B-HoA, B-Key, B-nonce-h)

In other words, B-Token-h is calculated by adding the home address B-HoA of the terminal B. A-HoA used to calculate B-Token-h is the source address of the HoTI message, and B-HoA is the destination address. Further, Sb(A-Token-h) included in the HoT message is means for preventing the terminal B from storing A-Token-h. A-Token-h is encrypted and sent back to the terminal A. Further, the terminal A includes it in a BU and sends it back to the terminal B. The terminal B decodes Sb(A-Token-h) added to the BU to acquire A-Token-h, and generates key data Key A using A-Token-h.

The terminal A may also send a CoTI in parallel with transmission of the HoTI. In other words, it may send the CoTI before receiving the HoT. Further, the CoTI may be sent before the HoTI. The terminal A sends the terminal B the CoTI with A-Token-c added thereto. The following method can be considered as the method of generating A-Token-c:

A-Token-c=HMAC SHA1 (B-CoA, A-Key, nonce)

B-CoA is the care-of address of the terminal B, and A-Key is a secret key of the terminal A. Nonce is a random number used by the terminal A to generate Care-of Token. The terminal B receives the CoTI from the terminal A and returns a CoT as a response. B-Token-c, B-nonce-c and Sb(A-Token-c) are included in the CoT. Unlike the conventional MIP, B-Token-c is calculated as follows:

B-Token-c=HMAC SHA1 (A-CoA, B-CoA, B-Key, B-nonce-c)

In other words, B-Token-c is calculated by adding the care-of address B-CoA of the terminal B. A-CoA used to calculate B-Token-c is the source address of the CoTI message, and B-CoA is the destination address. Like in the HoTI processing, Sb(A-Token-c) included in the CoT message is means for preventing the terminal B from storing A-Token-c.

When receiving a HoT as a response to the HoTI message and a CoT as a response to the CoTI message, the terminal A generates key data Key B using B-Token-h and B-Token-c included in the respective messages.

Key B=HMAC SHA1 (B-Token-h, B-Token-c)

Using the key data, the terminal A generates an authentication code B-MAC for a BU message.

B-MAC=HMAC SHA1 (Key B, BU message)

The terminal A sends the terminal B the BU message by adding B-nonce-h, B-nonce-c, B-MAC, Sb(A-Token-h), Sb(A-Token-c) and A-HoA, B-HoA.

The terminal B receives the BU message and generates B-Token-h using B-nonce-h, B-HoA and A-HoA. The terminal B also generates B-Token-c using the source address A-CoA of the BU message, the destination address B-CoA and B-nonce-c. Then, the terminal B generates Key B using the generated B-Token-h and B-Token-c, and checks whether B-MAC added to the BU message is correct. If the result of checking B-MAC is correct, the terminal B updates the life time of the binding cache of the terminal A. A new setting is also possible. On the other hand, if the result of checking B-MAC is not correct, the terminal B takes a measure such as to discard the message or return an error message.

Further, the terminal B performs decoding processing on the information Sb(A-Token-h) and Sb(A-Token-c) included in the BU message to acquire A-Token-h and A-Token-c. Then, the terminal B generates Key A as follows:

Key A=H MAC SHA1 (A-Token-h, A-Token-c)

Using the key data, the terminal B generates an authentication code A-MAC for a BA message.

A-MAC=HMAC SHA1 (Key A, BA message)

The terminal B adds, to the BA message, not only the authentication code B-MAC generated from Key B in the same manner as normal MIP, but also the authentication code A-MAC generated using new Key A. The terminal A receives the BA message, verifies the authentication code(s) using Key B and Key A, and if the verification result is correct, updates the life time of the binding cache of the terminal B. If the verification result of the authentication code(s) is not correct, the terminal A takes a measure such as to discard the message or return an error message.

Note that the above has described a case where Key A and Key B are separated from each other, but they may be combined into one piece of key data. For example, the following key data may be generated:

Key AB=HMAC SHA1 (A-Token-h, A-Token-c, B-Token-h, B-Token-c)

Further, the above has described the case where the terminal A stores A-Token-h and A-Token-c, but the configuration may be such that A-nonce-h and A-nonce-c is included in the BU message, and returned from the terminal B by including A-nonce-h and A-nonce-c in the BA message. In this case, when receiving the BA message, the terminal A can generate A-Token-h and A-Token-c from A-nonce-h and A-nonce-c, respectively, eliminating the need for the terminal A to store them.

Further, in the present invention, A-Token-h and A-Token-c are put into the HoTI message and the CoTI message, respectively, but any other combination may be considered. For example, the configuration may be such that A-Token-h is put into the CoTI message and A-Token-c is put into the HoTI message. Further, both Tokens may be put into the same message. In addition, A-Token-h and A-Token-c may be further divided and put into HoT and CoT messages separately.

Note that the HoTI message can be omitted. For example, the configuration may be such that a HoT and a CoT are returned as a response to a CoTI, including A-Token-h in a BU. Similarly, the CoTI can also be omitted. In this case, the configuration may be such that a HoT and a CoT are returned as a response to a HoTI, including A-Token-c in a BU. Further, after sending the HoTI, the terminal A may send the CoTI after receiving the HoT. Instead of storing the information included in the HoT message, the terminal A may send the CoTI message including the infromation and may obtain it returned back to itself by including it in the CoT message.

If the terminal B is a terminal that supports only the conventional MIP, the terminal B returns the same HoT and CoT as in the conventional MIP in response to the HoTI and CoTI from the terminal A. Since this allows the terminal A to find that the terminal B does not support the binding update of the present invention, the terminal A sends a BU message according to the conventional MIP.

Further, when the terminal A and the terminal B perform binding updates of the present invention at the same time, the following measures can be considered. Both binding updates may be performed intact. The waiting time from reception of HoT and CoT until transmission of BUs may be set at random to make it easy to avoid transmission of one BU.

Further, when both terminals perform binding updates, the length of the life time of the binding cache may change between the initiating side and the receiving side. The life time on the receiving side may be slightly shortened so that the initiating side of the next binding update will take a turn. In addition, the combined binding update processing of the present invention may be performed by a proxy node rather than by a mobile terminal itself.

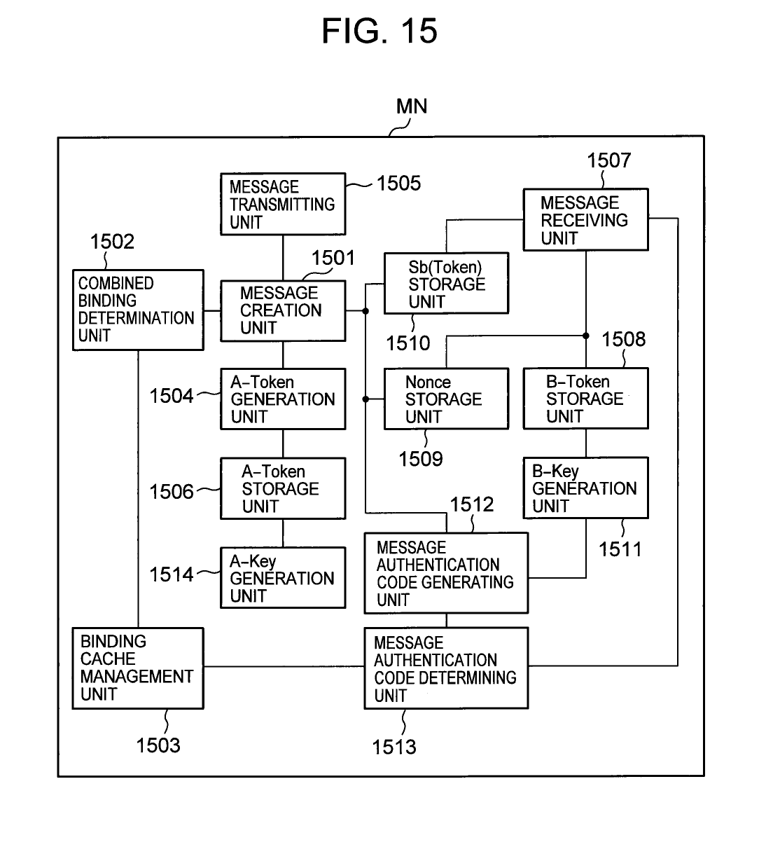

Next, a mobile terminal on the side of initiating a combined binding update will be described with reference to FIG. 15. First, transmission of a HoTI/CoTI will be described. A message creation unit 1501 requests a combined binding determination unit 1502 to determine whether the binding update is a normal binding update or a combined binding update. The combined binding determination unit 1502 checks whether a binding cache from a correspondent terminal, which is going to perform a binding update, is registered in a binding cache management unit 1503. If not registered, the normal binding update is performed.

If the combined binding update is performed, the message creation unit 1501 has an A-Token generation unit 1504 generate Home Token ((A-Token-h) and Care-of Token (A-Token-c), generates a HoTI message and CoTI message using the Tokens, and sends the messages from a message transmitting unit 1505. The Home Token and Care-of Token generated in the A-Token generation unit 1504 are stored in an A-Token storage unit 1506.

Next, reception of HoT and CoT will be described. HoT and CoT messages as response messages to the HoTI and CoTI messages are received at a message receiving unit 1507. The Tokens (B-Token-h, B-Token-c) and Nonce-IDs (identification numbers used by the mobile terminal on the responding side to call the Nonce values) generated by the correspondent terminal and included in the received HoT and CoT are stored in a B-Token storage unit 1508 and a Nonce storage unit 1509. Further, Sb(Home Token) and Sb(Care-of Token) added by the correspondent terminal are stored in an Sb(Token) storage unit 1510.

Next, transmission of a BU will be described. When receiving both the HoT message and the CoT message, since both the Home Token (B-Token-h) and the Care-of Token(B-Token-c) are gathered in the B-Token storage unit 1508, a B-Key generation unit 1511 generates key data using these Tokens.

Using the key data generated in the B-Key generation unit 1511, a message authentication code generating unit 1512 generates message authentication code(s), passes them to the message creation unit 1501. The message creation unit 1501 adds, to a BU message, the generated message authentication code(s) and two piece of data, Sb(Home Token) and Sb(Care-of Token), stored in the Sb(Token) storage unit 1510. The Nonce-IDs stored in the Nonce storage unit 1509 are also added to the BU message. Then, the BU message is sent from the message transmitting unit 1505.

Next, reception of a BA will be described. When the BA message is received at the message receiving unit 1507, a message authentication code determining unit 1513 makes a determination on the message. In order to determine the message, an A-Key generation unit 1514 extracts the Home Token (A-Token-h) and the Care-of Token(A-Token-c) stored in the A-Token storage unit 1506 to generate key data. The message authentication code generating unit 1512 generates message authentication code(s) using the key data generated by the A-Key generation unit 1514. The message authentication code determining unit 1513 compares the generated message authentication code(s) with the message authentication code(s) added to the BU message to determine whether both are identical.

If the message authentication code(s) are identical, the binding cache is registered in the binding cache management unit 1503. After that, the message creation unit 1501 creates a response to the BA message, and the message transmitting unit 1505 sends the response.

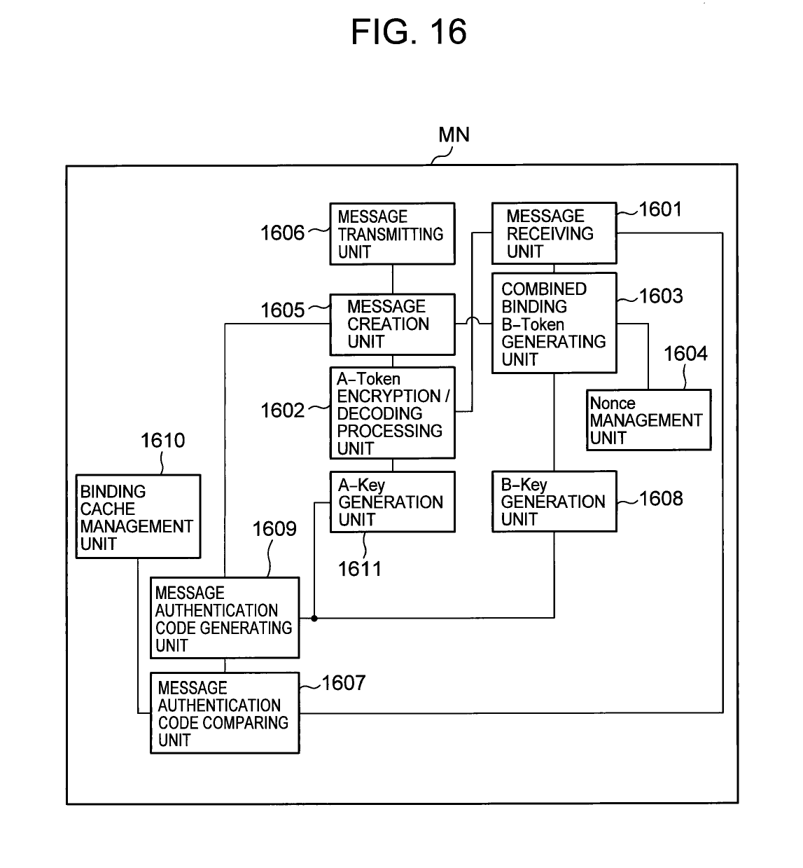

Next, a mobile terminal on the side of responding to a combined binding update will be described with reference to FIG. 16. First, reception of HoTI/CoTI will be described. HoTI and CoTI messages are received at a message receiving unit 1601. In the case of a combined binding update, Home Token(A-Token-h) or Care-of Token(A-Token-c) included in the messages is passed to an A-Token encryption/decoding processing unit 1602. Further, a combined binding B-Token generating unit 1603 generates B-Token (Home Token or Care-of Token). Nonce (home nonce or care-of nonce) necessary for generating B-Token is acquired from a Nonce management unit 1604.

B-Home Token=SHA1 (A-HoA, B-HoA, B-Key, B-home nonce)

B-Care-of Token=SHA1 (A-CoA, B-CoA, B-Key, B-care-of nonce)

Next, transmission of a HoT/CoT will be described. The A-Token encryption/decoding processing unit 1602 passes the encrypted data (Sb(Home Token(A-Token-h)) or Sb(Care-of Token(A-Token-c))) to a message creation unit 1605, and the message creation unit 1605 adds it to a response message. The Token (B-Token) generated by the combined binding B-Token generating unit 1603 and Nonce-ID for calling the Nonce used for the generation are acquired and added to the response message. When a received message is a HoTI, the response message is a HoT message, while when it is a CoTI, the response message is a CoT message. The response message created by the message creation unit 1605 is sent from a message transmitting unit 1606.

Next, reception of a BU will be described. A BU message is received at the message receiving unit 1601. In the case of a combined binding update, Home Token(B-Token-h) and Care-of Token(B-Token-c) are generated in the combined binding B-Token generating unit 1603. Nonce values are extracted from the Nonce management unit 1604 using Nonce-IDs included in the received BU message and used upon Token generation. Further, Sb(Home Token) and Sb(Care-of Token) included in the BU message are passed to the A-Token encryption/decoding processing unit 1602 in which they are decoded to acquire the original Home Token (A-Token-h) and Care-of Token (A-Token-c).

Further, message authentication code(s) included in the BU message are passed to a message authentication code comparing unit 1607. The Home Token(B-Token-h) and the Care-of Token(B-Token-c) generated in the combined binding B-Token generating unit 1603 are passed to a B-Key generation unit 1608, and key data is generated in the B-Key generation unit 1608.

Then, using the generated key data, message authentication code(s) are generated in a message authentication code generating unit 1609. In a message authentication code comparing unit 1607, the generated message authentication code(s) and the message authentication code(s) included in the BU message are compared to determine whether they are identical. If the message authentication code(s) are identical, a binding cache is set or updated in a binding cache management unit 1610.

Next, transmission of a BA will be described. Using the Tokens (A-Token-h, A-Token-c) decoded by the A-Token encryption/decoding processing unit 1602, key data is generated in an A-Key generation unit 1611, and message authentication code(s) are generated in the message authentication code generating unit 1609. The message creation unit 1605 adds the generated message authentication code(s) to a BA message. The BA message is sent from the message transmitting unit 1606. A response message to the BA message is received at the message receiving unit 1601, the message authentication code(s) are checked, and the binding cache is updated in the binding cache management unit 1610.

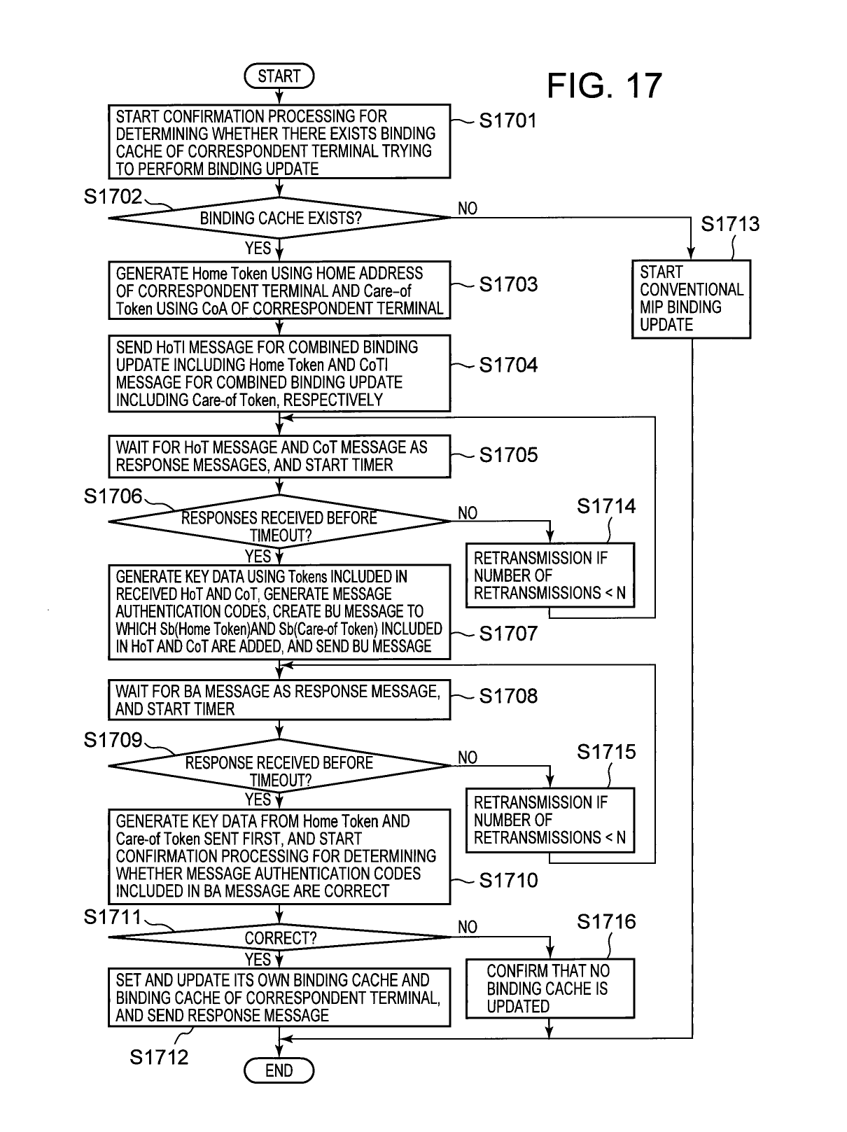

Next, a processing flow of a mobile terminal on the side of initiating a combined binding update will be described with reference to FIG. 17. As shown in FIG. 17, the mobile terminal starts confirmation processing for determining whether there is a correspondent terminal trying to perform a binding update (step S1701), and determines whether a binding cache of the correspondent terminal exists (step S1702). If a binding cache exists, the mobile terminal generates Home Token (A-Token-h) using the home address of the correspondent terminal and Care-of Token (A-Token-c) using the CoA of the correspondent terminal (step S1703).

Then, the mobile terminal sends a HoTI message for a combined binding update including the Home Token and a CoTI message for a combined binding update including the Care-of Token, respectively (step S1704). The mobile terminal starts a timer while waiting for a HoT message and a CoT message as response messages (step S1705). The mobile terminal determines whether responses (messages) have been received before a timeout (step S1706).

If the response messages have been received before the timeout, the mobile terminal creates a BU message. In other words, the mobile terminal generates key data using Tokens included in the received HoT and CoT, generates message authentication code(s), creates and sends the BU message to which the generated message authentication code(s), and Sb(Home Token(A-Token-h)) and Sb(Care-of Token(A-Token-c)) included in the HoT and CoT are added (step S1707). The mobile terminal starts the timer while waiting for a BA message as a response message (step S1708). The mobile terminal determines whether the response (message) has been received before the timeout (step S1709).

If the response message has been received before the timeout, the mobile terminal generates key data from the Home Token (A-Token-h) and Care-of Token (A-Token-c) sent first, and starts confirmation processing for determining whether message authentication code(s) included in the BA message are correct (step S1710). The mobile terminal determines whether the message authentication code(s) are correct (step S1711), and if determining whether they are correct, the mobile terminal sets and updates its own binding cache and a binding cache of the correspondent terminal, and sends a response message (step S1712).

In step S1702, if it is determined whether no binding cache exists, the mobile terminal starts a conventional MIP binding update (step S1713). Further, in step S1706 or S1709, if no response message has been received before the timeout, retransmission is performed on condition that the number of retransmissions is smaller than a predetermined numerical value N (step S1714, S1715). Further, in step S1711, if it is determined whether the message authentication code(s) are incorrect, it is confirmed that no binding cache is updated (step S1716).

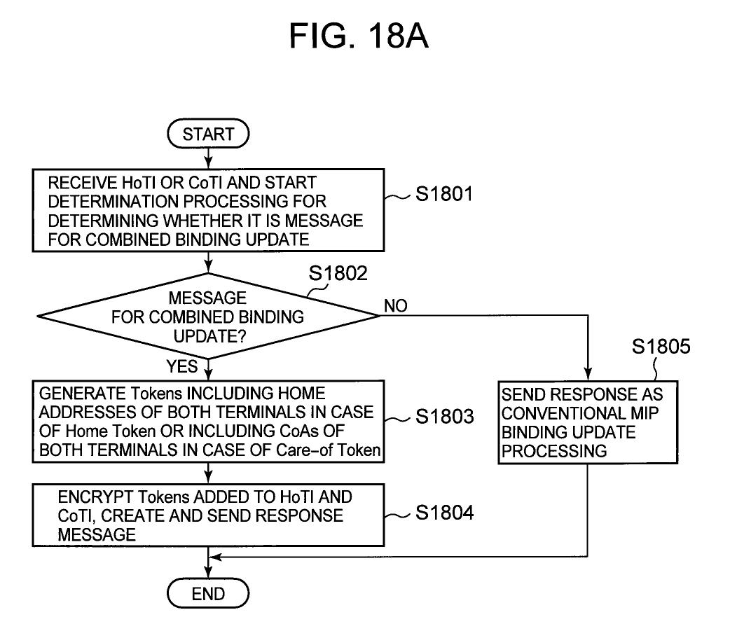

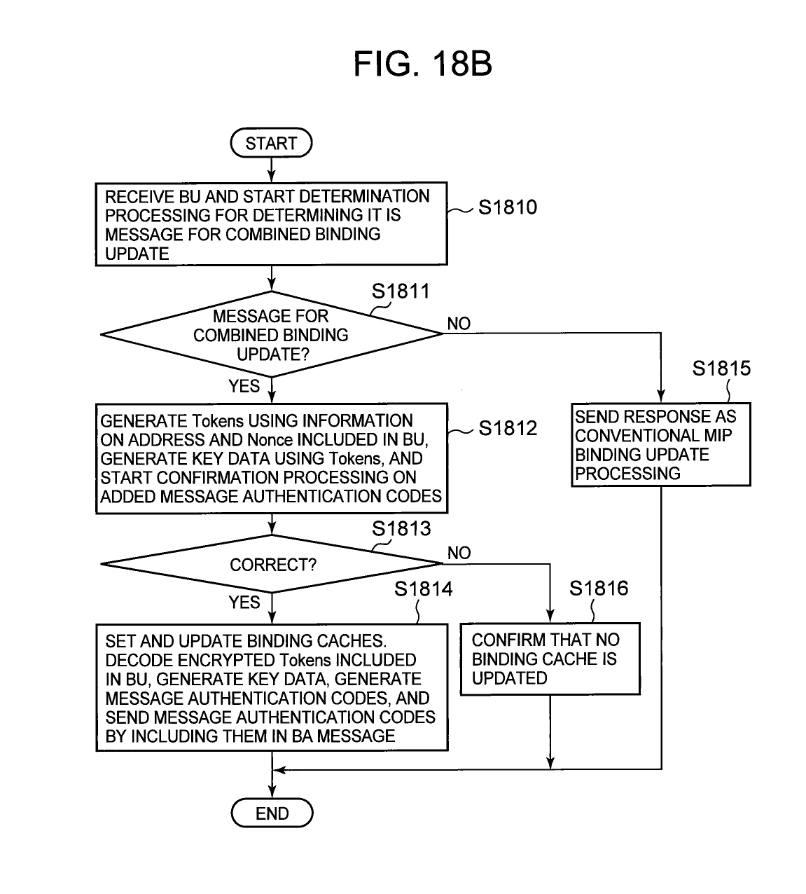

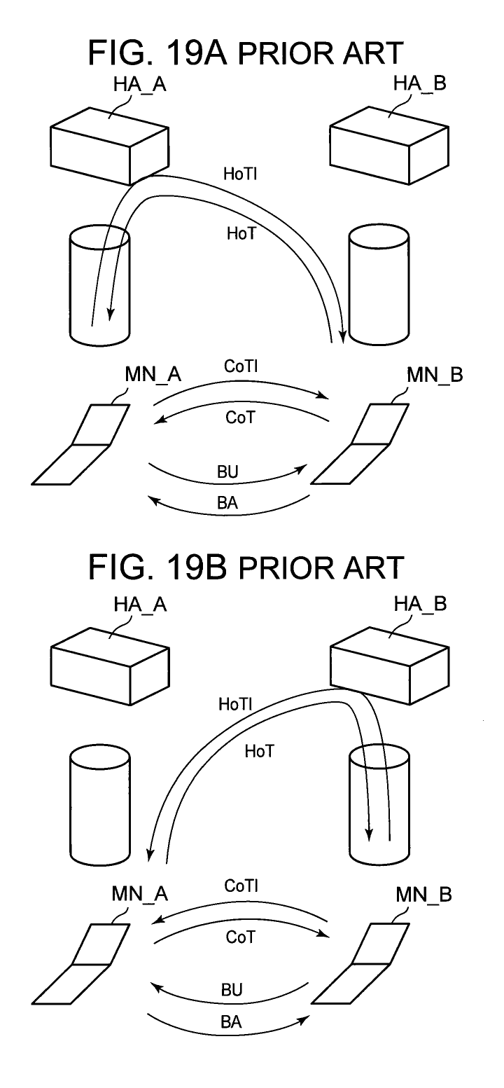

Next, a processing flow of a mobile terminal on the side of responding to a combined binding update (from reception of a message for the combined binding update to transmission of a response message) will be described with reference to FIG. 18A. As shown in FIG. 18A, the mobile terminal receives a HoTI or a CoTI, and starts determination processing for determining whether it is a message for the combined binding update (step S1801). The mobile terminal determines whether it is a message for the combined binding update (step S1802), and if it is the message for the combined binding update, Tokens including the home addresses of both terminals in the case of Home Token or including the CoAs of both terminals in the case of Care-of Token are generated (step S1803).

The mobile terminal encrypts the Tokens (A-Token-h, A-Token-c) added to the HoTI and CoTI, creates and sends a response message (step S1804). In step S1802, if determining whether it is not a message for the combined binding update, the mobile terminal sends a response as conventional MIP binding update processing (step S1805).

Next, a processing flow of a mobile terminal on the side of responding to a combined binding update (from reception of a BU message to transmission of a BA message) will be described with reference to FIG. 18B. As shown in FIG. 18B, the mobile terminal receives a BU (message), and starts determination processing for determining whether it is a message for the combined binding update (step S1810). The mobile terminal determines whether it is a message for the combined binding update (step S1811), and if it is the message for the combined binding update, Tokens (B-Token-h, B-Token-c) are generated using information on address and Nonce included in the BU, key data is generated using the Tokens, and confirmation processing on the added message authentication code(s) is started (step S1812).

The mobile terminal determines whether the message authentication code(s) are correct (step S1813), and if correct, the mobile terminal sets and updates binding caches, decodes the encrypted Tokens (A-Token-h, A-Token-c) included in the BU, generates key data, generates message authentication code(s), and sends the message authentication code(s) by including them in a BA message (step S1814). In step S1811, if it is not a message for the combined binding update, the mobile terminal starts a conventional MIP binding update (step S1815). Further, in step S1813, if determining whether the message authentication code(s) are incorrect, the mobile terminal confirms that no binding cache is set and updated (step S1816).

Each of the functional blocks used in describing the aforementioned embodiments of the present invention is implemented as an LSI (Large Scale Integration) typified by an integrated circuit. These may be made up of one chip individually, or they may be made up of one chip to include some or all of them. Here, although the LSI is assumed, it may be called an IC (Integrated Circuit), a system LSI, a super LSI, or an ultra LSI depending on the degree of integration. Further, the technique for creation of an integrated circuit is not limited to LSI, and it may be implemented by a private circuit or a general-purpose processor. An FPGA (Field Programmable Gate Array) capable of programming after LSI manufacturing or a reconfigurable processor capable of reconfiguring connections or settings of circuit cells within the LSI may also be employed. In addition, if integrated circuit technology capable of replacing LSI emerges with the development of semiconductor technology or another technology derived therefrom, the technology may of course be used to integrate the functional blocks. For example, applications of biotechnology may be possible.

### INDUSTRIAL APPLICABILITY

A binding updating method and a mobile terminal used by the method according to the present invention can reduces the number of messages required during binding update performed between both terminals. The reduction in the number of messages can result in reduction in power consumption of each terminal, and further reduction in processing time required for binding update between both terminals. Therefore, the present invention is effective in a binding updating method for updating binding between communication terminals between which a path is optimized by binding update, and a mobile terminal used by the method.

1. A binding update method for updating binding information for enabling route optimization between a first mobile terminal and a second mobile terminal as a correspondent terminal of the first mobile terminal, and
when the first mobile terminal has the binding information on the second mobile terminal, the method comprising the steps of:
causing the first mobile terminal to send the second mobile terminal a first pair of messages as messages including predetermined information on the first mobile terminal to acquire predetermined information on the second mobile terminal from the second mobile terminal;
causing the second mobile terminal to send the first mobile terminal a second pair of messages including the predetermined information on the second mobile terminal;
causing the first mobile terminal to send the second mobile terminal a third message to which authentication information is added, the authentication information generated based on the predetermined information on the second mobile terminal included in the second pair of messages;
causing the second mobile terminal to send the first mobile terminal a fourth message as a message including response information to the third message and to which authentication information is added, the authentication information generated based on the predetermined information on the first mobile terminal, and to update the binding information when the authentication information from the first mobile terminal is valid; and
causing the first mobile terminal to update the binding information when the authentication information added to the fourth message from the second mobile terminal is valid.

2. The binding update method according to claim 1, wherein
the second mobile terminal sends the first mobile terminal the predetermined information on the first mobile terminal by including the predetermined information in the second pair of messages, and
the first mobile terminal sends the second mobile terminal the predetermined information on the first mobile terminal included in the second pair of messages by including the predetermined information on the first mobile terminal in the third message.

3. The binding update method according to claim 2, wherein the second mobile terminal sends the predetermined information on the first mobile terminal by including the predetermined information on the first mobile terminal in the second pair of messages in such a format that the predetermined information on the first mobile terminal can be decoded by only the second mobile terminal.

4. The binding update method according to claim 1, wherein
the predetermined information on the first mobile terminal is a token (Token) generated based on a home address and a care-of address (CoA) of the second mobile terminal,
the predetermined information on the second mobile terminal is a token (Token) generated based on a home address and a care-of address (CoA) of the first mobile terminal,
the first pair of messages are messages for requesting the second mobile terminal to start a home address test (Home Test Init) and a care-of address test (Care-Of Test Init),
the second pair of messages are a HoT message and a CoT message to respond to the first pair of messages,
the third message is a binding update message to the second mobile terminal, and
the fourth message is a binding update message to the first mobile terminal.

5. A mobile terminal used by a binding update method for updating binding information for enabling route optimization between the mobile terminal and a correspondent terminal as a communication partner of the mobile terminal, and
when the mobile terminal has the binding information on the correspondent terminal, the mobile terminal comprising:
message creation means for creating a first pair of messages as messages including predetermined information on the mobile terminal to acquire predetermined information on the correspondent terminal from the correspondent terminal;
transmitting means for sending the generated first pair of messages to the correspondent terminal;
receiving means for receiving, from the correspondent terminal, a second pair of messages including the predetermined information on the correspondent terminal;
authentication information generating means for generating authentication information based on the received predetermined information on the correspondent terminal; and
updating means for updating the binding information, wherein
the message creation means creates a third message to which the authentication information generated by the authentication information generating means is added,
the transmitting means sends the generated third message to the correspondent terminal, and
the updating means determines whether authentication information as information received through the receiving means and generated by the correspondent terminal based on the predetermined information on the mobile terminal is valid, and if valid, the updating means updates the binding information.

6. A mobile terminal used by a binding update method for updating binding information for enabling route optimization between the mobile terminal and a correspondent terminal as a communication partner of the mobile terminal, the mobile terminal comprising:
receiving means for receiving a first pair of messages as messages including predetermined information on the correspondent terminal to acquire predetermined information on the mobile terminal from the mobile terminal;
message creation means for creating a second pair of messages including the predetermined information on the mobile terminal;
transmitting means for sending the correspondent terminal the generated second pair of messages;
authentication information generating means for generating authentication information based on the predetermined information on the correspondent terminal received through the receiving means; and
updating means for updating the binding information when authentication information as information received through the receiving means and generated by the correspondent terminal based on the predetermined information on the mobile terminal is valid, wherein
the message creation means creates a third message to which the authentication information generated by the authentication information generating means is added, and
the transmitting means sends the generated third message to the correspondent terminal.

7. The mobile terminal according to claim 5, wherein the message creation means creates the third message including the predetermined information on the mobile terminal included in the second pair of messages.

8. The mobile terminal according to claim 6, wherein the message creation means creates the second pair of messages including the predetermined information on the correspondent terminal included in the first pair of messages.

9. The mobile terminal according to claim 7, wherein the message creation means includes the predetermined information on the correspondent terminal in the third message in such a format that the predetermined information on the correspondent terminal can be decoded by only the mobile terminal.

10. The mobile terminal according to claim 8, wherein the message creation means includes the predetermined information on the correspondent terminal in the second pair of messages in such a format that the predetermined information on the correspondent terminal can be decoded by only the mobile terminal.

11. The mobile terminal according to claim 5, wherein
the predetermined information on the mobile terminal is a token (Token) generated based on a home address and a care-of address (CoA) of the correspondent terminal,
the predetermined information on the correspondent terminal is a token (Token) generated based on a home address and a care-of address (CoA) of the mobile terminal,
the first pair of messages are messages for requesting the correspondent terminal to start a home address test (Home Test Init) and a care-of address test (Care-Of Test Init),
the second pair of messages are a HoT message and a CoT message to respond to the first pair of messages, and
the third message is a binding update message to the correspondent terminal.

12. The mobile terminal according to claim 6, wherein
the predetermined information on the correspondent terminal is a token (Token) generated based on a home address and a care-of address (CoA) of the mobile terminal,
the predetermined information on the mobile terminal is a token (Token) generated based on a home address and a care-of address (CoA) of the correspondent terminal,
the first pair of messages are messages for requesting the mobile terminal to start a home address test (Home Test Init) and a care-of address test (Care-Of Test Init),
the second pair of messages are a HoT message and a CoT message to respond to the first pair of messages, and
the third message is a binding update message to the correspondent terminal.

13. A binding update method for updating binding information for enabling route optimization between a first mobile terminal and a second mobile terminal as a correspondent terminal of the first mobile terminal, and
when the first mobile terminal has the binding information on the second mobile terminal, the method comprising the steps of:
causing the first mobile terminal to send the second mobile terminal a first pair of messages as messages including predetermined information on the first mobile terminal to acquire predetermined information on the second mobile terminal from the second mobile terminal;
causing the second mobile terminal to send the first mobile terminal a second pair of messages including the predetermined information on the first mobile terminal and the predetermined information on the second mobile terminal;
causing the first mobile terminal to send the second mobile terminal a third message to which authentication information is added, the predetermined information on the first mobile terminal and the authentication information generated based on the predetermined information on the second mobile terminal included in the second pair of messages;
causing the second mobile terminal to send the first mobile terminal a fourth message as a message including response information to the third message and to which authentication information is added, the authentication information generated based on the predetermined information on the first mobile terminal, and to update the binding information when the authentication information from the first mobile terminal is valid; and
causing the first mobile terminal to update the binding information when the authentication information added to the fourth message from the second mobile terminal is valid, wherein
the predetermined information on the first mobile terminal is a token (Token) generated based on a home address and a care-of address (CoA) of the second mobile terminal,
the predetermined information on the second mobile terminal is a token (Token) generated based on a home address and a care-of address (CoA) of the first mobile terminal,
the first pair of messages are messages for requesting the second mobile terminal to start a home address test (Home Test Init) and a care-of address test (Care-Of Test Init),
the second pair of messages are a HoT message and a CoT message to respond to the first pair of messages,
the third message is a binding update message to the second mobile terminal, and
the fourth message is a binding update message to the first mobile terminal.

14. The binding update method according to claim 13, wherein the second mobile terminal sends the predetermined information on the first mobile terminal by including the predetermined information on the first mobile terminal in the second pair of messages in such a format that the predetermined information on the first mobile terminal can be decoded by only the second mobile terminal.

15. A mobile terminal used by a binding update method for updating binding information for enabling route optimization between the mobile terminal and a correspondent terminal as a communication partner of the mobile terminal, and
when the mobile terminal has the binding information on the correspondent terminal, the mobile terminal comprising:
message creation means for creating a first pair of messages as messages including predetermined information on the mobile terminal to acquire predetermined information on the correspondent terminal from the correspondent terminal;
transmitting means for sending the generated first pair of messages to the correspondent terminal;
receiving means for receiving, from the correspondent terminal, a second pair of messages including the predetermined information on the mobile terminal and the predetermined information on the correspondent terminal;
authentication information generating means for generating authentication information based on the received predetermined information on the correspondent terminal; and
updating means for updating the binding information, wherein
the message creation means creates a third message to which the authentication information generated by the authentication information generating means and the predetermined information on the mobile terminal are added,
the transmitting means sends the generated third message to the correspondent terminal, and
the updating means determines whether authentication information as information received through the receiving means and generated by the correspondent terminal based on the predetermined information on the mobile terminal is valid, and if valid, the updating means updates the binding information, wherein
the predetermined information on the mobile terminal is a token (Token) generated based on a home address and a care-of address (CoA) of the correspondent terminal,
the predetermined information on the correspondent terminal is a token (Token) generated based on a home address and a care-of address (CoA) of the mobile terminal,
the first pair of messages are messages for requesting the correspondent terminal to start a home address test (Home Test Init) and a care-of address test (Care-Of Test Init),
the second pair of messages are a HoT message and a CoT message to respond to the first pair of messages, and
the third message is a binding update message to the correspondent terminal.

16. The mobile terminal according to claim 15, wherein the message creation means includes the predetermined information on the correspondent terminal in the third message in such a format that the predetermined information on the correspondent terminal can be decoded by only the mobile terminal.

17. A mobile terminal used by a binding update method for updating binding information for enabling route optimization between the mobile terminal and a correspondent terminal as a communication partner of the mobile terminal, the mobile terminal comprising:
receiving means for receiving a first pair of messages as messages including predetermined information on the correspondent terminal to acquire predetermined information on the mobile terminal from the mobile terminal;
message creation means for creating a second pair of messages including the predetermined information on the mobile terminal and the predetermined information on the correspondent terminal;
transmitting means for sending the correspondent terminal the generated second pair of messages;
authentication information generating means for generating authentication information based on the predetermined information on the correspondent terminal received through the receiving means; and
updating means for updating the binding information when authentication information as information received through the receiving means and generated by the correspondent terminal based on the predetermined information on the mobile terminal is valid, wherein
the message creation means creates a third message to which the authentication information generated by the authentication information generating means is added, and
the transmitting means sends the generated third message to the correspondent terminal, wherein
the predetermined information on the correspondent terminal is a token (Token) generated based on a home address and a care-of address (CoA) of the mobile terminal,
the predetermined information on the mobile terminal is a token (Token) generated based on a home address and a care-of address (CoA) of the correspondent terminal,
the first pair of messages are messages for requesting the mobile terminal to start a home address test (Home Test Init) and a care-of address test (Care-Of Test Init),
the second pair of messages are a HoT message and a CoT message to respond to the first pair of messages, and
the third message is a binding update message to the correspondent terminal.

18. The mobile terminal according to claim 17, wherein the message creation means includes the predetermined information on the correspondent terminal in the second pair of messages in such a format that the predetermined information on the correspondent terminal can be decoded by only the mobile terminal.
